(19) United States
(12) Patent Application Publication
(10) Pub. No.: US 2021/0312560 A1
(43) Pub. Date: Oct. 7, 2021

(54) MACHINE LEARNING SYSTEMS AND METHODS FOR ELASTICITY ANALYSIS

(71) Applicant: State Farm Mutual Automobile Insurance Company, Bloomington, IL (US)

(72) Inventor: Gregory L. Hayward, Bloomington, IL (US)

(21) Appl. No.: 16/293,260

(22) Filed: Mar. 5, 2019

Related U.S. Application Data
(60) Provisional application No. 62/745,067, filed on Oct. 12, 2018.
(60) Provisional application No. 62/674,366, filed on May 21, 2018.
(60) Provisional application No. 62/702,526, filed on Jul. 24, 2018.

(51) Int. Cl. G06Q 40/08; G06N 20/00; G06N 5/04

(52) U.S. Cl. CPC G06Q 40/08; G06N 5/048; G06N 20/00

(57) ABSTRACT

A machine learning system determines an estimate of elasticity of an insurance policy. The system includes one or more processors in communication with at least one memory device, the one or more processors programmed to store an insurance policy model including a plurality of characteristics for the insurance policy and historical insurance policy data including a plurality of individual insurance policies. The one or more processors are further programmed to execute the insurance policy model to calculate an estimate of elasticity of the insurance policy based upon analyzing the historical data to detect a change to a characteristic of the insurance policy. The one or more processors are further programmed to modify a characteristic based upon the calculated elasticity. The processors are further programmed to receive a user insurance application, generate an individualized insurance policy based upon the application and the modified characteristic, and transmit the individualized insurance policy.

### RELATED APPLICATIONS

This application is related to U.S. Provisional Patent Application No. 62/745,067, filed Oct. 12, 2018, entitled “MACHINE LEARNING SYSTEMS AND METHODS FOR ELASTICITY ANALYSIS”; U.S. Provisional Patent Application No. 62/675,366, filed May 23, 2018, entitled “EMERGING TREND DETECTION FOR RISK MITIGATION & PREVENTION”; and U.S. Provisional Patent Application No. 62/702,526, filed Jul. 24, 2018, entitled “ELASTICITY MEASUREMENT FOR NEW BUSINESS ACQUISITION AND POLICY RENEWAL,” the entire contents and disclosures of which are hereby incorporated by reference herein in their entireties.

### FIELD OF THE DISCLOSURE

The present disclosure relates to artificial intelligence systems and methods for continuously measuring elasticity, and, more specifically, machine learning techniques for analyzing changes in selection behavior for new and repeat selections.

### BACKGROUND

Identifying which offers are optimal for new and repeat transactions requires analysis by dynamic systems. Minor changes in policies and prices may result in significant changes in demand. For example, normally determining price elasticity for goods and services is a long and drawn out process performed by actuaries analyzing historical data sets over periods of time. In some cases, the process of determining price elasticity requires analyzing data acquired over several months or years. These calculations also require considering many variables. For example, changes to product offerings by all market participants may need to be analyzed to get an accurate picture. Conventional techniques for determining elasticity may include other drawbacks, such as inefficiencies in conducting the analysis, inconveniences and difficulties over data collection, time delays before the impact of price changes is reflected in selection behavior, time required to conduct the analysis taking so long as to no longer be applicable in highly dynamic markets, expense and/or costs to locate and hire resources to conduct the analysis, and ineffectiveness or inapplicability of the results. Accordingly, it would be useful to have dynamic systems for analyzing the elasticities of demand based upon price and other changes to policies.

### BRIEF SUMMARY

The present disclosure generally relates to systems and methods for measuring elasticity, or measuring estimates of elasticity, for new business acquisition and/or policy renewal or lapse/cancellation. New insurance policy data, existing insurance policy data, and/or other data may be collected and analyzed by artificial intelligence or machine learning modules to identify customer segments associated with insurance policies; determine one or more changes to insurance contract parameters or variables for each customer segment; and then determine a measure of elasticity for new policy issuance or policy renewal caused by the one or more changes. For instance, elasticity may be measured or identified as being associated with price, premium, rates, discounts, coverages, deductibles, limits, conditions, endorsements, or other insurance contract variables. The customer segments may relate to age, tenure, line of business, state or geographical region, multi-lines, marital status, employment status, and/or other segments.

In one aspect, a computerized machine learning system for determining an estimate of elasticity of an insurance policy may be provided. The computerized machine learning system may include one or more processors in communication with at least one memory device. The one or more processors are programmed to store an insurance policy model including a plurality of characteristics for the insurance policy and historical insurance policy data. The historical insurance policy data may include a plurality of individual insurance policies. The one or more processors are further programmed to execute the insurance policy model to calculate an estimate of elasticity of the insurance policy. The calculation is based upon analyzing the historical insurance policy data to detect a change to at least one characteristic of the plurality of characteristics of the insurance policy. The one or more processors are further programmed to modify at least one characteristic of the plurality of characteristics of the insurance policy based upon the calculated estimate of elasticity. The one or more processors are further programmed to receive, from a user computing device, a user insurance application. The one or more processors are further programmed to generate an individualized insurance policy based upon the application and the at least one modified characteristic. The one or more processors are further programmed to transmit, to the user computing device, the individualized insurance policy. The computerized machine learning system may have additional, less, or alternate functionality, including that discussed elsewhere herein.

In another aspect, a computer-implemented method for determining an estimate of elasticity of an insurance policy may be provided. The method may be implemented using a computer system including one or more processors in communication with at least one memory device. The method includes storing an insurance policy model including a plurality of characteristics for the insurance policy and historical insurance policy data. The historical insurance policy data may include a plurality of individual insurance policies. The method further includes executing the insurance policy model to calculate an estimate of elasticity of the insurance policy. The calculation may be based upon analyzing the historical insurance policy data to detect a change to at least one characteristic of the plurality of characteristics of the insurance policy. The method further includes modifying at least one characteristic of the insurance policy based upon the calculated estimate of elasticity. The method further includes receiving, from a user computing device, a user insurance application. The method further includes generating an individualized insurance policy based upon the application and the at least one modified characteristic. The method further includes transmitting, to the user computing device, the individualized insurance policy. The method may have additional, less, or alternate functionality, including that discussed elsewhere herein.

In another aspect, a computerized machine learning system for determining a rate of change of new insurance policy issuances is provided. The computerized machine learning system may include one or more processors in communication with at least one memory device. The one or more processors are programmed to store an insurance policy model including a plurality of characteristics for the insurance policy and historical insurance policy data. The historical insurance policy data includes a plurality of individual insurance policies. The one or more processors may be further programmed to execute the insurance policy model to calculate a rate of change of new insurance policy issuances. The calculation may be based upon analyzing the historical insurance policy data to detect a change to at least one characteristic of the plurality of characteristics of the insurance policy. The one or more processors may be further programmed to modify at least one characteristic of the insurance policy based upon the calculated rate of change. The one or more processors may be further programmed to receive, from a user computing device, a user insurance application. The one or more processors may be further programmed to generate an individualized insurance policy offer based upon the application and the at least one modified characteristic. The one or more processors may be further programmed to transmit, to the user computing device, the individualized insurance policy. The computerized machine learning system may have additional, less, or alternate functionality, including that discussed elsewhere herein.

In yet another aspect, a computer-implemented method of determining (price or other) elasticity for insurance policies from analyzing renewal data, lapse data, cancellation data, sales data, existing or new policy data, mobile device data, website data, browsing data, online purchasing data, social media data, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy, and/or new or recently issued insurance policies (such as new auto, life, or homeowners insurance policies); (2) inputting, via one or more processors, the new insurance policy data, the existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), (ii) a change or update to one or more characteristics of the new insurance policies (such as a change to, or associated with, premium, price, rate, discount, coverage, limits, conditions, deductibles, endorsements, or other parameters) within each customer segment identified, and/or (iii) an actual measure of elasticity for, or an actual rate of change of, new policy issuance (for each of the one or more customer segments) based upon, caused by, or associated with the change or update to the one or more characteristics of the new insurance policies; (3) estimating, via one or more processors, an estimated measure of elasticity for, or an estimated rate of change of, new policy issuance (for the one or more customer segments within the new insurance policies) based upon the change or update to the one or more characteristics of the new insurance policies (for the one or more customer segments within the new insurance policies), or alternatively, retrieving, via one or more processors, a historical or past measure of elasticity for, or a historical or past rate of change of, new policy issuance (for the one or more customer segments) based upon the change or update to the one or more characteristics of the new insurance policies; (4) comparing, via one or more processors, the actual measure of elasticity for, or the actual rate of change of, new policy issuance, with the estimated or historical/past measure of elasticity for, or the estimated or historical/past rate of change of new policy issuance (for the one or more customer segments), respectively; and/or (5) determining, via one or more processors, if the actual measure of elasticity, or the actual rate of change of new policy issuance, deviates from the estimated or historical/past measure of elasticity, or the estimated or historical/past rate of change of new policy issuance, respectively, by a greater than a predetermined threshold, and (6) if so, then adjusting the change or update in insurance policies that are being or planned to be subsequently newly issued (such as to minimize or reduce the impact of the change or update on new policy issuance). The method may include additional, less, or alternate actions, including those discussed elsewhere herein and directly below.

In another aspect, a computer-implemented method of determining (price or other) elasticity for insurance policies from analyzing renewal data, lapse data, cancellation data, sales data, existing or new policy data, mobile device data, website data, browsing data, online purchasing data, social media data, and/or other data may be provided. The method may include (1) receiving, via one or more processors and/or associated transceivers, new insurance policy data, existing policy data, and/or other data, the new insurance policy data including data in several data fields, the new insurance policy data associated with a type of new (or newly issued) insurance policy, and/or new insurance policies; (2) inputting, via one or more processors, the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), (ii) a change or update to one or more characteristics of the new insurance policies (such as a change to premium, price, rate, discount, coverage, limits, conditions, deductibles, endorsements, and/or other parameters) within each customer segment identified, and/or (iii) an actual measure of elasticity for, or an actual rate of change of, policy renewal and/or policy lapse/cancellation (for the one or more customer segments) based upon, caused by, or associated with the change or update to the one or more characteristics of the new insurance policies; (3) estimating, via one or more processors, an estimated measure of elasticity for, or an estimated rate of change of, policy renewal and/or policy lapse/cancellation (for the one or more customer segments) based upon the change or update to the one or more characteristics of the new insurance policies, or alternatively, retrieving, via one or more processors, a historical or past measure of elasticity for, or a historical or past rate of change of, policy renewal and/or policy lapse/cancellation (for the one or more customer segments) based upon the change or update to the one or more characteristics of the new insurance policies; (4) comparing, via one or more processors, the actual measure of elasticity for, or the actual rate of change of, policy renewal and/or policy lapse/cancellation, with the estimated or historical/past measure of elasticity for, or the estimated or historical/past rate of change of, policy renewal and/or lapse/cancellation (for the one or more customer segments), respectively; and/or (5) determining, via one or more processors, if the actual measure of elasticity, or the actual rate of change of, policy renewal and/or lapse/cancellation deviates from the estimated or historical/past measure of elasticity, or the estimated or historical/past rate of change of, policy renewal and/or lapse/cancellation, respectively, by a greater than a predetermined threshold, and (6) if so, then adjusting the change or update in insurance policies that are being or planned to be subsequently newly issued (such as to facilitating reducing the impact of the change or update on policy renewal and/or policy lapse/cancellation). The method may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts one embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing environment in which techniques for training a neural network to identify or determine elasticity or measure of elasticity for, or a rate of change of, new business acquisition or new policy issuance, and/or policy renewal or lapse/cancellation, based upon changes in insurance contracts, such as changes to price, premium, rate, discount, coverages, deductibles, limits, conditions, endorsements, or other insurance contract variables, may be implemented, according to one embodiment;

FIG. 2 depicts an exemplary computing environment in which techniques for collecting and processing user input, and training a neural network to identify or determine elasticity or measure of elasticity for, or a rate of change of, new business acquisition or new policy issuance, and/or policy renewal or lapse/cancellation, may be implemented, according to one embodiment;

FIG. 3 depicts an exemplary artificial neural network which may be trained by the neural network unit of FIG. 1 or the neural network training application of FIG. 2, according to one embodiment and scenario;

FIG. 4 depicts an exemplary neuron, which may be included in the artificial neural network of FIG. 3, according to one embodiment and scenario;

FIGS. 5-12 depict exemplary computer-implemented methods of using machine learning techniques to identify or determine elasticity or measure of elasticity for, or a rate of change of, new business acquisition or new policy issuance, and/or policy renewal or lapse/cancellation, based upon changes in insurance contracts, such as changes to price, premium, rate, discount, coverages, deductibles, limits, conditions, endorsements, or other insurance contract variables;

FIG. 13 depicts a computer-implemented method for operating an adaptive insurance policy system;

FIG. 14 illustrates an exemplary block diagram of an adaptive insurance policy system;

FIG. 15 illustrates an exemplary configuration of an exemplary user computing device; and

FIG. 16 depicts an exemplary configuration of an exemplary server computing device.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Machine Learning Systems for Adaptive Insurance Policies

The present embodiments are directed to employing, inter alia, machine learning techniques to discover, identify, or determine elasticity or a measure of elasticity for (such as an estimate of elasticity), or a rate of change of, new business acquisition or new policy issuance, and/or policy renewal or lapse/cancellation, based upon changes in new insurance contracts, such as changes to price, premium, rate, discount, coverages, deductibles, limits, conditions, endorsements, or other insurance contract variables. The insurance policies may relate to auto, homeowners, renters, personal articles, life, and health insurance. Once elasticity or a measure of elasticity is identified, the change and/or modification to subsequently issued insurance policies of the same type may be adjusted to reach a target or desired level of new business acquisition or new policy issuance, and/or policy renewal or lapse/cancellation. The elasticity or measure of elasticity identified may be for customer segments identified in new or existing insurance policies, such as segments related to age, marital status, state, line of business, employment status, frequent shopper, tenure, etc.

In some embodiments, such as embodiments directed toward supervised machine learning, data input to a machine learning/training model may be harvested from historical policies and/or claims and may include make, model, year, miles, technological features, and/or other characteristics of a vehicle, vehicle operation monitoring systems, whether a claim is paid or not paid, liability (e.g., types of injuries, where treated, how treated, etc.), disbursements related to a claim such as hotel costs and other payouts, autonomous vehicle features and characteristics, etc. Additional inputs to the machine learning/training model may include vehicle telematics data for automobiles, and for real property, home telematics data received from a smart home controller, such as how long and when are the doors unlocked, how often is the security system armed, how long is the vehicle in operation during time periods, etc.

The present embodiments may facilitate discovering new measures of elasticity that may be utilized to set or establish further changes to insurance contract variables. The present embodiments may dynamically characterize or analyze new insurance policies and/or claims, and/or dynamically determine the impact of changes to one or more insurance contract variable on new policy issuance, and/or policy renewal/cancellation. The present embodiments may also dynamically update pricing models to facilitate better matching insurance premium price to actual risk.

### Exemplary Environment for Identifying Elasticity for Changes to New Insurance Policies

The embodiments described herein may relate to, inter alia, determining or identifying elasticity or a measure of elasticity from a plurality of inputs, including new and existing insurance policy data, claim data, and/or other data. More particularly, in some embodiments, one or more neural network models may be trained using historical insurance policy and/or claim data as training input. An application may be provided to a client computing device (e.g., a smartphone, tablet, laptop, desktop computing device, wearable, or other computing device) of a user. A user of the application, who may be an employee of a company employing the methods described herein or a customer of that company, may enter input into the application via a user interface or other means.

The input may be transmitted from the client computing device to a remote computing device (e.g., one or more servers) via a computer network, and then processed further, including by applying input entered into the client device to the one or more trained neural network models to produce labels and weights, for example, indicating net or individual risk, insurance contract variable, or other factors. The factors may be identified in electronic policy and/or claim records. Although historical policies and claims may be used in training one or more neural network models, electronic policy and claims information may be streaming in real-time or with near real-time latencies (e.g., on the order of 10 ms or less) along with all input information to tune the artificial intelligence system, in a dynamic process.

Optionally, the remote computing device may receive the input and determine, using a trained neural network, one or more elasticity indicators applicable to the input, and/or an elasticity level. Herein elasticity indicators may be expressed numerically, as strings (e.g., as labels), or in any other suitable format. Elasticity levels may be expressed as Boolean values (e.g., risk/no risk), scaled quantities (e.g., from 0.0-1.0), or in any other suitable format. The determined elasticity indicators and/or elasticity level may be displayed to the user, and/or may be provided as input to another application (e.g., to an application which uses the elasticity indicators and calculated elasticity in a quotation calculation or for other purposes).

A quotation may include a price, parameters describing a vehicle or home, and/or one or more identified elasticity indicators, among other information. By transmitting input to the remote computing device for processing and analysis, an accurate risk level based upon a wealth of historical knowledge may be determined, and provided to the user in what may appear to the user to be a very rapid, even instantaneous, manner.

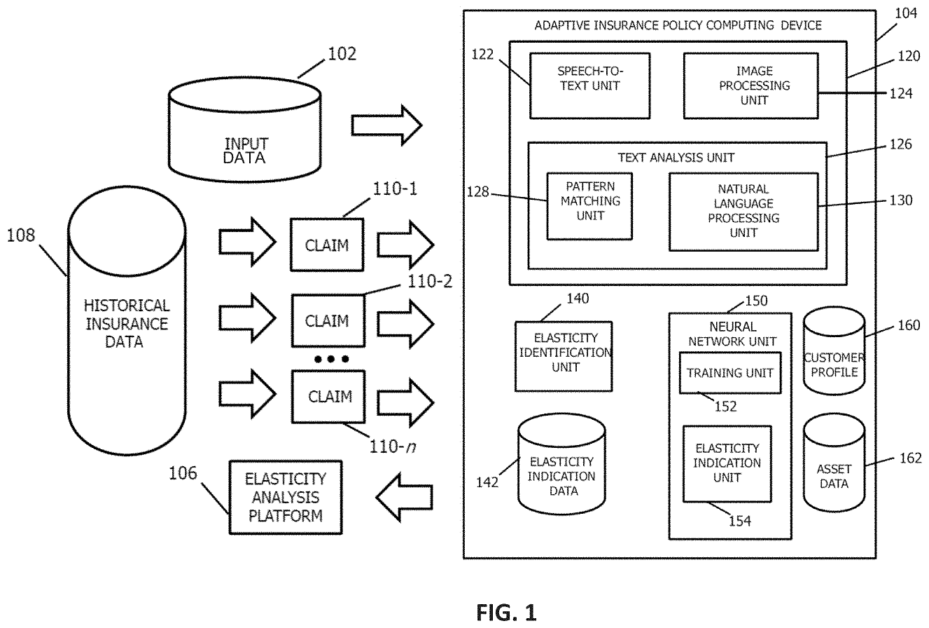

Turning to FIG. 1, an exemplary computing environment 100, representative of an artificial intelligence platform for insurance, is depicted. Environment 100 may include input data 102 (such as new insurance policy, mobile device, and/or other data) and historical insurance data 108 (such as historical existing insurance policy data, and/or historical or existing claim data), both of which may comprise a list of parameters, a plurality (e.g., thousands or millions) of electronic documents, or other information. As used herein, the term “data” generally refers to information related to an insurance policy, a customer, and/or an insured or insurable asset, such as a vehicle, home, vehicle operator, or homeowner, which exists in the environment 100. For example, data may include an electronic document representing an existing or new insurance policy, a vehicle (e.g., automobile, truck, boat, motorcycle, etc.) or homeowners insurance policy or claim, demographic information about the vehicle or home, autonomous vehicle, vehicle operator, and/or information related to the type of vehicle or vehicles owned or being operated by the vehicle operator, and/or other information.

Data may be historical or current. Although data may be related to new insurance policies, existing insurance policies, and/or an ongoing claim filed by a vehicle operator or homeowner, in some embodiments, data may consist of raw data parameters entered by a human user of the environment 100 or which is retrieved/received from another computing system.

Data may or may not relate to the new business acquisition or new policy issuance, and/or policy renewal or policy lapse/cancellation. The data may or may not also relate to claims filing process, and while some of the examples described herein refer to auto insurance claims, it should be appreciated that the techniques described herein may be applicable to other types of electronic documents, in other domains. For example, the techniques herein may be applicable to identifying elasticity, or measures thereof in relation to insurance contract changes, in other insurance domains, such as agricultural insurance, homeowners insurance, health or life insurance, renters insurance, personal articles insurance, etc. In that case, the scope and content of the data may differ, in addition to the domain-specific training and operational requirements applicable to the neural network(s).

As another example, data may be collected from an existing customer file, such as a customer with an existing insurance policy and/or a customer filing a claim, a potential or a prospective customer applying for an insurance policy, or may be supplied by a third party, such as a company other than the proprietor of the environment 100. In some cases, data may reside in paper files that are scanned or entered into a digital format by a human or by an automated process (e.g., via a scanner). Generally, data may comprise any digital information, from any source, created at any time.

Input data 102 and historical insurance data 108 may both include new insurance policy data, existing insurance policy data, and/or claim data associated with auto, homeowners, renters, personal articles, life, health, and other types of insurance. Such policy and claim data may be organized into several data fields, or codes, including those discussed elsewhere herein. Input data 102 and historical insurance data 108 may include other types of data, such as mobile device, vehicle, and/or home sensor data, autonomous or smart vehicle operating and control data, image and audio data, vehicle and home telematics data, and/or types of data collected with the customer's affirmative consent or permission.

Input data 102 may be loaded into an insurance policy computing device 104 to organize, analyze, and process input data 102 in a manner that facilitates efficient determination or identification of elasticity by elasticity analysis platform 106. The loading of input data 102 may be performed by executing a computer program on a computing device that has access to the environment 100, and the loading process may include the computer program coordinating data transfer between input data 102 and insurance policy computing device 104 (e.g., by the computer program providing an insurance policy computing device 104 as to an address or location at which input data 102 is stored).

AI (artificial intelligence) platform may reference this address to retrieve records from input data 102 to perform elasticity, pattern, trend and/or anomaly analysis and determination techniques. insurance policy computing device 104 may be thought of as a collection of algorithms configured to receive and process parameters, and to produce labels and, in some embodiments, elasticity, pattern, trend, anomaly, risk and/or pricing information.

As discussed further below, insurance policy computing device 104 may be used to train multiple neural network models relating to different granular segments of, for auto insurance, vehicles or vehicle operators. For example, insurance policy computing device 104 may be used to train a neural network model to detect elasticity for new auto policies related to autonomous vehicles or individual autonomous or semi-autonomous features or systems. In another embodiment, insurance policy computing device 104 may be used to train a neural network model for use in identifying an elasticity for auto insurance policies related to, or involving, motorcycles in a particular state or locality.

In the embodiment of FIG. 1, insurance policy computing device 104 may include input analysis unit 120. Input analysis unit 120 may optionally include speech-to-text unit 122, and/or image processing unit 124 which may comprise, respectively, algorithms for converting human speech into text and analyzing images (e.g., extracting information from hotel and rental receipts). In this way, data may comprise audio recordings (e.g., recordings made when a customer telephones a customer service center) that may be converted to text and further used by insurance policy computing device 104. In some embodiments, veracity information associated with the claim data may be used by input analysis unit 120 and used by insurance policy computing device 104 to weight the data accordingly, and/or to train and operate neural network models.

Input analysis unit 120 may also include text analysis unit 126, which may include pattern matching unit 128 and natural language processing (NLP) unit 130. In some embodiments, text analysis unit 126 may determine facts regarding policy inputs (premium, discounts, limits, deductibles, conditions, coverages, etc.) and/or claim inputs (e.g., the amount of money paid under a claim, repair/replacement cost, cause of loss code, etc.). Amounts may be determined in a currency- and inflation-neutral manner, so that the amounts may be directly compared. In some embodiments, text analysis unit 126 may analyze text produced by speech-to-text unit 122 and/or image processing unit 124.

In some embodiments, pattern matching unit 128 may search textual claim data loaded into insurance policy computing device 104 for specific strings or keywords in text, including semantic information relating to entities, such as people, vehicles, homes, and other objects.

Relevant verbs and objects, as opposed to verbs and objects of lesser relevance, may be determined by the use of a machine learning algorithm analyzing historical policies and/or claims. For example, both a driver, type of vehicle, and a deer may be relevant objects. Verbs indicating collision or injury may be relevant verbs. In some embodiments, text analysis unit 126 may comprise text processing algorithms (e.g., lexers and parsers, regular expressions, etc.) and may emit structured text in a format which may be consumed by other components.

In the embodiment of FIG. 1, insurance policy computing device 104 may include a elasticity identification unit 140 to determine or identifying elasticity associated with changes in new insurance policies based upon analysis of data. Elasticity, patterns, and/or trends may be quantified or calculated with respect to individual attributes or elements of data, such as by assigning a score between 0 and 1 to a given attribute, field, data field, code, characteristic or classification code. In other embodiments, elasticity identification unit 140 may determine an indication of elasticity for a change in new insurance policies by generating labels which pertain to data in whole, or in part. This labeling may be accomplished in various different ways, depending upon the embodiment.

For example, elasticity identification unit 140 may label input data 102, or portions thereof, according to positive or negative pattern matching according to pattern matching unit 128. Alternately, in some embodiments, elasticity identification unit 140 may label input data 102, which may be raw data or a claim filed by a customer, according to results obtained from natural language processing unit 130. Elasticity identification unit 140 may label input data 102 according to Boolean values or pre-determined ranges.

Labels may be saved to and/or retrieved from an electronic database, such as elasticity indication data 142, and labels may be generated from already-existing labels, and/or dynamically created labels (i.e., labels created at runtime) by elasticity identification unit 140. A set of labels may be associated with a set of input data 102, and the creation of new labels may be partially or entirely based upon existing labels and/or input data 102.

Dynamic creation of labels may, in some embodiments, be based upon user attributes and/or metadata. For example, a resident of the Eastern United States may be assigned a label related to weather or another attribute unique to the region.

As noted, in some embodiments, elasticity identification unit 140 may analyze input data 102 (e.g., label claims) through the use of a neural network unit 150. Neural network unit 150 may use an artificial neural network, or simply “neural network.” The neural network may be any suitable type of neural network, including, without limitation, a recurrent neural network or feed-forward neural network. The neural network may include any number (e.g., thousands) of nodes or “neurons” arranged in multiple layers, with each neuron processing one or more inputs to generate a decision or other output.

In some embodiments, neural network models may be chained together, so that output from one model is fed into another model as input. For example, elasticity identification unit 140 may, in one embodiment, apply input data 102 to a first neural network model that is trained to generate labels. The output (e.g., labels) of this first neural network model may be fed as input to a second neural network model which has been trained to predict or identify (potential or actual) emerging trends based upon the presence of labels. In one embodiment, the second neural network may be trained using additional data (e.g., mobile device, sensor, vehicle, and/or home data) to verify the potential or actual emerging trend actual exists.

Neural network unit 150 may include training unit 152, and elasticity indication unit 154. To train the neural network to identify elasticity associated with changes in new insurance policies, neural network unit 150 may access electronic policies within historical insurance data 108. Historical insurance data 108 may comprise a corpus of documents and/or images comprising many (e.g., millions) of insurance policies and/or claims which may contain data linking a particular customer or claimant to one or more vehicles, and which may also contain, or be linked to, information pertaining to the customer. In particular, historical insurance data 108 may be analyzed by insurance policy computing device 104 to generate policy and/or claim records 110-1 through 110-n, where n is any positive integer. Each policy and/or claim 110-1 through 110-n may be processed by training unit 152 to train one or more neural networks to identify policy and/or claim-related trends, such as claim frequency or severity, including by pre-processing of historical insurance data 108 using input analysis unit 120 as described above.

Neural network 150 may, from a trained model, identify labels that correspond to specific data, metadata, and/or attributes within input data 102, depending on the embodiment. For example, neural network 150 may be provided with instructions from input analysis unit 120 indicating that one or more particular types of insurance is associated with one or more portions of input data 102.

Neural network 150 may identify one or more insurance types or variables associated with the one or more portions of input data 102 (e.g., premiums, discounts, coverages, limits, conditions, endorsements, deductibles, bodily injury, property damage, collision coverage, comprehensive coverage, liability insurance, med pay, or personal injury protection (PIP) insurance) and by input analysis unit 120. In one embodiment, the one or more insurance types or variables may be identified by training the neural network 150 based upon types of peril, and/or cause of loss.

In addition, input data 102 may indicate a particular customer and/or vehicle. In that case, elasticity identification unit 140 may look up additional customer and/or vehicle information from customer data 160 and asset data 162, respectively. For example, the age of the vehicle operator and/or vehicle type may be obtained. The additional customer and/or asset information may be provided to neural network unit 150 and may be used to analyze and label input data 102 and, ultimately, may be used to determine or identify elasticity or measure of elasticity associated with a change in new insurance policies.

In one embodiment, the training process may be performed in parallel, and training unit 152 may analyze all or a subset of policies and/or claims 110-1 through 110-n. Specifically, training unit 152 may train a neural network to identify one or more quantities measures of elasticity for changes in new policies associated with the policy or claim records 110-1 through 110-n. As noted, insurance policy computing device 104 may analyze input data 102 to arrange the historical policies or claims into policy and claim records 110-1 through 110-n, where n is any positive integer.

In some embodiments, policy and claim records 110-1 through 110-n may be organized in a flat list structure, in a hierarchical tree structure, or by means of any other suitable data structure. For example, the claim records may be arranged in a tree wherein each branch of the tree is representative by line of business by state. There, each of policy and claim records 110-1 through 110-n may represent a single policy or claim, or may represent multiple policy or claim records arranged in a group or tree.

Further, policy and claim records 110-1 through 110-n may comprise links to claims, customers, vehicle, or other insurable assets (e.g., personal articles or homes) whose corresponding data is located elsewhere. In this way, one or more policies and claims may be associated with one or more customers, and one or more vehicles via one-to-many and/or many-to-one relationships. Policy and claim data and/or other data, including sensor, audio, or image data, may be data indicative of a particular risk or risks associated with a given policy or claim, customer, and/or vehicle. The status of claim records may be completely settled, or in various stages of settlement.

As used herein, the term “claim” generally refers to an electronic document, record, or file, that represents an insurance claim (e.g., an automobile, homeowners, life, or health insurance claim) submitted by a policy holder of an insurance company. Herein, “claim data” may generally refers to data directly entered by the customer or insurance company including, without limitation, free-form text notes, photographs, digital images, mobile device files, audio recordings, written records, receipts (e.g., hotel and rental car), and other information including data from legacy, including pre-Internet (e.g., paper file), systems. Notes from claim adjusters and attorneys may also be included. Claim data may include data entered by third parties, such as information from a repair shop, hospital, doctor, police report, etc.

In one embodiment, policy and/or claim data may include policy and/or claim metadata or external data, which generally refers to data pertaining to the claim that may be derived from claim data or which otherwise describes, or is related to, the policy and/or claim but may not be part of the electronic policy and/or claim record. Policy and/or claim metadata may have been generated directly by a developer of the computing environment 100, for example, or may have been automatically generated as a direct product or byproduct of a process carried out in environment 100. For example, policy and/or claim metadata may include a field indicating whether a claim was settled or not settled, and amount of any payouts, and the identity of corresponding payees.

Another example of policy and/or claim metadata is the geographic location, such as a state, in which a claim is submitted, which may be obtained via a global positioning system (GPS) sensor in a device used by the person or entity submitting the claim. Yet another example of policy and/or claim metadata includes a category of the claim type (e.g., collision, liability, uninsured or underinsured motorist, etc.). For example, a single claim in historical insurance data 108 may be associated with a married couple, and may include the name, address, and other demographic information relating to the couple. Additionally, the policy and/or claim may be associated with multiple vehicles owned or leased by the couple, and may contain information pertaining to those vehicles including without limitation, the vehicles' make, model, year, condition, mileage, autonomous or semi-autonomous vehicle features, etc.

The policy and/or claim may include a plurality of policy and/or claim data and metadata, including metadata indicating a relationship or linkage to other policies or claims in historical policy or claim data 110. In this way, neural network unit 150 may produce a neural network that has been trained to associate the presence of certain input parameters with one or more potential or actual trends or anomalies.

Once the neural network has been trained, elasticity indication unit 154 may apply the trained neural network to input data 102 as processed by input analysis unit 120. In one embodiment, input analysis unit 120 may merely “pass through” input data 102 without modification. The output of the neural network, indicating risk indications, such as labels pertaining to the entirety of, or portions of input data 102, may then be provided to elasticity identification unit 140. Elasticity identification unit 140 may insert the output of the neural network (e.g., labels) into an electronic database, such as elasticity indication data 142. Alternatively, or additionally, elasticity indication unit 154 may use label information output by the neural network to determine attributes of input data 102, and may provide those attributes to elasticity identification unit 140.

In some embodiments, each label or attribute may be associated with a confidence score and/or weight. Confidence scores may be assigned based upon the source of the information (e.g., if the information is from asset data 274, then a score of 1.0 may be assigned; whereas, if the information is inferred and/or provided by a user, a lower confidence score may be assigned). Elasticity identification unit 140 may then forward the labels and/or scores to elasticity analysis platform 106.

Insurance policy computing device 104 may further include customer data 160 and asset data 162, which elasticity identification unit 140 may leverage to provide useful input parameters to neural network unit 150. Customer data 160 may be an integral part of insurance policy computing device 104, or may be located separately from insurance policy computing device 104. In some embodiments, customer data 160 or asset or vehicle data 162 may be provided to insurance policy computing device 104 via separate means (e.g., via an API call), and may be accessed by other units or components of environment 100. Either may be provided by a third-party service.

Customer data 160 may include mobile device data, vehicle or home telematics data, smart or autonomous vehicle feature data, intelligent home data, vehicle-mounted sensor or system data, home-mounted sensor or system data, other sensor data, or other data generated by the customer computing devices and shared with their permission or affirmative consent.

Asset or vehicle data 162 may include data related to customer vehicles or homes, again collected and analyzed with the customer's permission. For instance, asset data 162 may be a database comprising information describing vehicle makes and models, including information about model years and model types (e.g., model edition information, engine type, any upgrade packages, etc.). Asset or vehicle data 162 may indicate whether certain make and model year vehicles are equipped with safety features (e.g., lane departure warnings). The asset data 162 may also relate to autonomous or semi-autonomous vehicle features or technologies of the vehicle, and/or sensors, software, and electronic components that direct the autonomous or semi-autonomous vehicle features or technologies.

In the case of homes, asset data 162 may include features of home, such as roofing, flooring, tiling, siding, number of floors, floor plan, square footage, size of yard, etc., and whether such home is equipped with one or more smart home features, including smart sprinkler systems or smart security systems. Both of customer data 160 and asset data 162 may be used to train a neural network model.

In some embodiments, pattern matching unit 128 and natural language processing unit 130 may act in conjunction to determine labels. For example, pattern matching unit 128 may include instructions to identify words indicating contact (e.g., “hit”, “crash”, or “collide”). Matched data may be provided to natural language processing unit 130, which may further process the matched data to determine parts of speech such as verbs and objects, as well as relationships between the objects.

The output of natural language processing unit 130 may be provided to neural network unit 150 and used by training unit 152 to train a neural network model to label insurance types. Further, additional processing, including by the use of an additional neural network model, maybe used to assign weight to a label. For example, a collision involving a deer may receive a higher weight than one involving a rabbit.

The labels in elasticity indication data 142 may be provided to elasticity analysis platform 106 which may perform a calculation using the labels and/or weights. For example, in one embodiment, elasticity analysis platform 106 may sum the weights of a field or code within the claim data.

The methods and systems described herein may help risk-averse customers to lower their insurance premiums by more granularly identifying elasticity for new insurance policies. The methods and systems may also allow new customers to receive more accurate pricing when they are shopping for vehicle or home insurance products. All of the benefits provided by the methods and systems described herein may be realized much more quickly than traditional modeling approaches. The methods and systems herein may reduce, in some cases dramatically, insurance company expenses and/or insurance customer premiums, due to increased efficiencies and improved predictive accuracies.

### Exemplary Training Model System

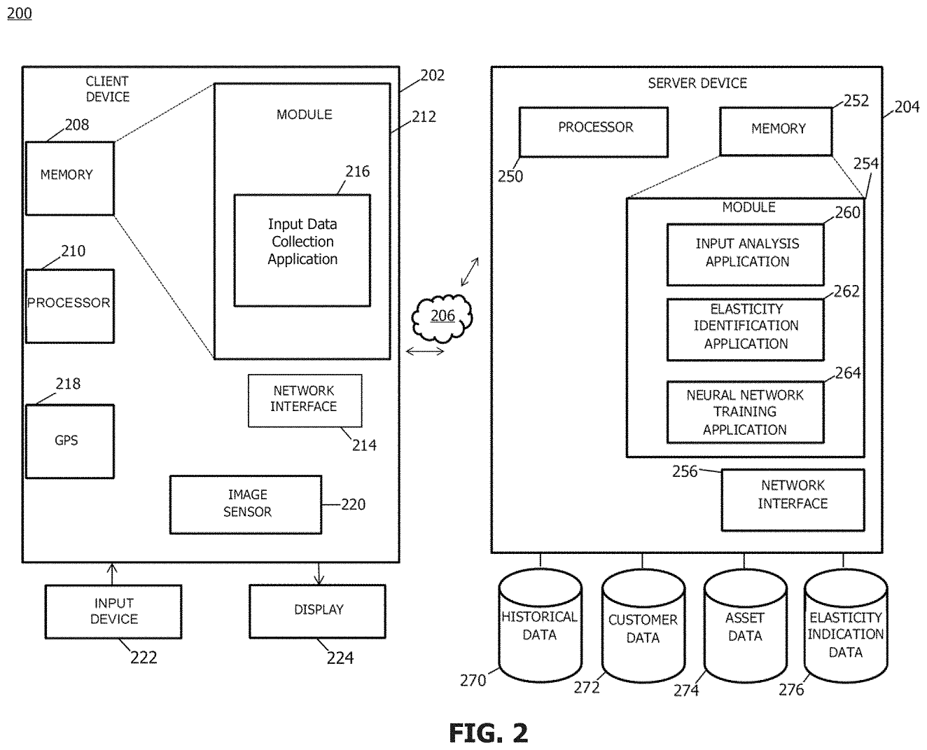

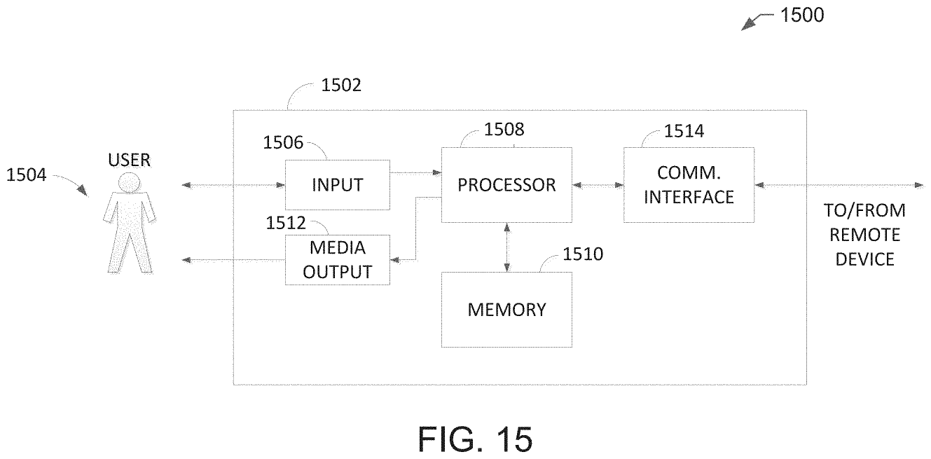

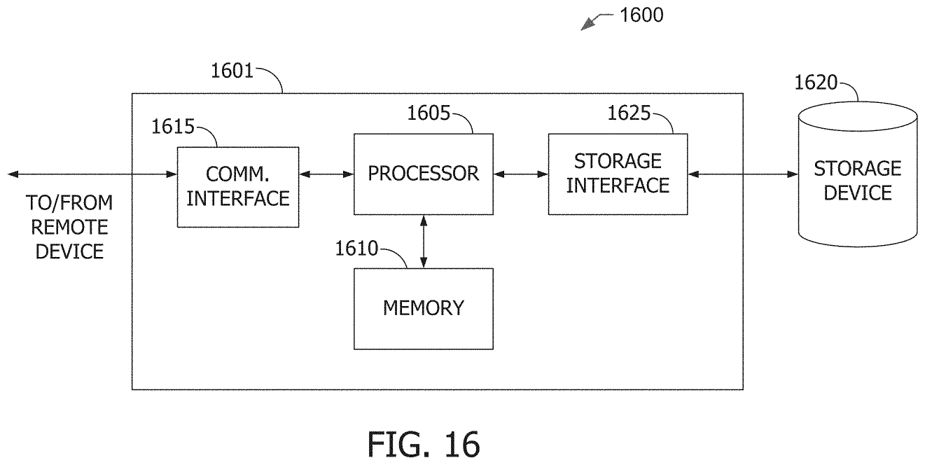

With reference to FIG. 2, a high-level block diagram of an elasticity training model system 200 is illustrated that may implement communications between a client device 202 and a server device 204 via network 206 to provide elasticity or measures of elasticity (due to changes in new policies) identification, classification, and/or analysis. FIG. 2 may correspond to one embodiment of computing environment 100 of FIG. 1, and also includes various user/client-side components. For simplicity, client device 202 is referred to herein as client device 202, and server device 204 is referred to herein as server device 204. Client device 202 may be similar to user computing device 1502 shown in FIG. 15. Server device 204 may be similar to server computing device 1601 shown in FIG. 16. Server device 204 may host services relating to neural network training and operation, and may be communicatively coupled to client device 202 via network 206.

Although only one client device is depicted in FIG. 2, it should be understood that any number of client devices 202 may be supported. Client device 202 may include a memory 208 and a processor 210 for storing and executing, respectively, a module 212. While referred to in the singular, processor 210 may include any suitable number of processors of one or more types (e.g., one or more CPUs, graphics processing units (GPUs), cores, etc.). Similarly, memory 208 may include one or more persistent memories (e.g., a hard drive and/or solid state memory).

Module 212, stored in memory 208 as a set of computer-readable instructions, may be related to an input data collection application 216 which, when executed by the processor 210, causes input data to be stored in memory 208. The data stored in memory 208 may correspond to, for example, raw data retrieved from input data 102. Input data collection application 216 may be implemented as web page (e.g., HTML, JavaScript, CSS, etc.) and/or as a mobile application for use on a standard mobile computing platform.

Input data collection application 216 may store information in memory 208, including the instructions required for its execution. While the user is using input data collection application 216, scripts and other instructions comprising input data collection application 216 may be represented in memory 208 as a web or mobile application. The input data collected by input data collection application 216 may be stored in memory 208 and/or transmitted to server device 204 by network interface 214 via network 206, where the input data may be processed as described above to determine a elasticity or measures of various elasticity or elasticities in new insurance policy data, and/or insurance policy data-related fields, parameters, or codes. In one embodiment, input data collection application 216 may be data used to train a model (e.g., scanned claim data).

Client device 202 may also include GPS sensor 218, an image sensor 220, user input device 222 (e.g., a keyboard, mouse, touchpad, and/or other input peripheral device), and display interface 224 (e.g., an LED screen). User input device 222 may include components that are integral to client device 202, and/or exterior components that are communicatively coupled to client device 202, to enable client device 202 to accept inputs from the user. Display 224 may be either integral or external to client device 202, and may employ any suitable display technology. In some embodiments, input device 222 and display 224 are integrated, such as in a touchscreen display. Execution of the module 212 may further cause the processor 210 to associate device data collected from client device 202 such as a time, date, and/or sensor data (e.g., a camera for photographic or video data) with insured or insurable asset data (e.g., vehicle or home-related data) and/or customer data, such as data retrieved from customer data 160 and asset data 162, respectively.

In some embodiments, client device 202 may receive data from elasticity indication data 142 and elasticity analysis platform 106. Such data, indicating elasticity, or measures of elasticity, corresponding to various changes to new insurance policies, may be presented to a user of client device 202 by a display interface 224.

Execution of the module 212 may further cause the processor 210 of the client device 202 to communicate with the processor 250 of the server device 204 via network interface 214 and network 206. As an example, an application related to module 212, such as input data collection application 216, may, when executed by processor 210, cause a user interface to be displayed to a user of client device 202 via display interface 224. The application may include graphical user input (GUI) components for acquiring data (e.g., photographs) from image sensor 220, GPS coordinate data from GPS sensor 218, and textual user input from user input device(s) 222.

The processor 210 may transmit the aforementioned acquired data to server device 204, and processor 250 may pass the acquired data to a neural network, which may accept the acquired data and perform a computation (e.g., training of the model, or application of the acquired data to a trained neural network model to obtain a result). With specific reference to FIG. 1, the data acquired by client device 202 may be transmitted via network 206 to a server implementing insurance policy computing device 104, and may be processed by input analysis unit 120 before being applied to a trained neural network by elasticity identification unit 140.

As described with respect to FIG. 1, the processing of input from client device 202 may include associating customer data 160 and asset data 162 with the acquired data. The output of the neural network may be transmitted, by a trend identification unit corresponding to elasticity identification unit 140 in server device 204, back to client device 202 for display (e.g., in display 224) and/or for further processing.

Network interface 214 may be configured to facilitate communications between client device 202 and server device 204 via any hardwired or wireless communication network, including network 206 which may be a single communication network, or may include multiple communication networks of one or more types (e.g., one or more wired and/or wireless local area networks (LANs), and/or one or more wired and/or wireless wide area networks (WANs) such as the Internet). Client device 202 may cause insurance elasticity related data to be stored in server device 204 memory 252 and/or a remote insurance related database such as customer data 160.

Server device 204 may include a processor 250 and a memory 252 for executing and storing, respectively, a module 254. Module 254, stored in memory 252 as a set of computer-readable instructions, may facilitate applications related to processing and/or collecting insurance elasticity related data, including policy and claim data and metadata, and insurance policy application data. For example, module 254 may include input analysis application 260, elasticity identification application 262, and neural network training application 264, in one embodiment.

Input analysis application 260 may correspond to input analysis unit 120 of environment 100 of FIG. 1. Elasticity indication application 262 may correspond to elasticity identification unit 140 of environment of FIG. 1, and neural network training application 264 may correspond to neural network unit 150 of computing environment 100 of FIG. 1. Module 254 and the applications contained therein may include instructions which, when executed by processor 250, cause server device 204 to receive and/or retrieve input data from (e.g., raw data and/or an electronic policy or claim) from client device 202. In one embodiment, input analysis application 260 may process the data from client 202, such as by matching patterns, converting raw text to structured text via natural language processing, by extracting content from images, by converting speech to text, and so on.

Throughout the aforementioned processing, processor 250 may read data from, and write data to, a location of memory 252 and/or to one or more databases associated with server device 204. For example, instructions included in module 254 may cause processor 250 to read data from input analysis application 260, which may be communicatively coupled to server device 204, either directly or via communication network 206. Input analysis application 260 may correspond to historical insurance data 108, and processor 250 may contain instructions specifying analysis of a series of electronic claim documents from input analysis application 260, as described above with respect to claims 110-1 through 110-n of historical insurance data 108 in FIG. 1.

Processor 250 may query customer data 272 and insured or insurable asset data 274 for data related to respective electronic policy and/or claim documents and raw data, as described with respect to FIG. 1. In one embodiment customer data 272 and asset data 274 correspond, respectively, customer data 160 and asset data 162. In another embodiment, customer data 272 and/or asset data 274 may not be integral to server device 204. Module 254 may also facilitate communication between client device 202 and server device 204 via network interface 256 and network 206, in addition to other instructions and functions.

Although only a single server device 204 is depicted in FIG. 2, it should be appreciated that it may be advantageous in some embodiments to provision multiple servers for the deployment and functioning of input data 102. For example, the pattern matching unit 128 and natural language processing unit 130 of input analysis unit 120 may require CPU-intensive processing. Therefore, deploying additional hardware may provide additional execution speed. Each of input analysis application 260, customer data 272, asset data 274, and elasticity indication data 276 may be geographically distributed.

While the databases depicted in FIG. 2 are shown as being communicatively coupled to server device 204, it should be understood that historical policy and/or input analysis application 260, for example, may be located within separate remote servers or any other suitable computing devices communicatively coupled to server device 204. Distributed database techniques (e.g., sharding and/or partitioning) may be used to distribute data. In one embodiment, a free or open source software framework such as Apache Hadoop® may be used to distribute data and run applications (e.g., elasticity indication application 262). It should also be appreciated that different security needs, including those mandated by laws and government regulations, may in some cases affect the embodiment chosen, and configuration of services and components.

In a manner similar to that discussed above in connection with FIG. 1, historical policies and/or claims from historical policy and/or input analysis application 260 may be ingested by server device 204 and used by neural network training application 264 to train an artificial neural network. Then, when module 254 processes input from client device 202, the data output by the neural network(s) (e.g., data indicating labels, risks, weights, etc.) may be passed to elasticity indication application 262 for computation, quantification, or identification of one or more elasticities, or measures of elasticity, in new policies, new policy data, or new policy data fields, which may be expressed in alpha-numeric, boolean, decimal, or any other suitable format. The calculated elasticity or measure of elasticity may then be transmitted to client device 202 and/or another device. The calculated elasticity or measure of elasticity may be used for further processing by client device 202, server device 204, or another device.

It should be appreciated that the client/server configuration depicted and described with respect to FIG. 2 is but one possible embodiment. In some cases, a client device such as client device 202 may not be used. In that case, input data may be entered, programmatically, or manually, directly into device 204. A computer program or human may perform such data entry. In that case, device may contain additional or fewer components, including input device(s) and/or display device(s).

The most useful embodiment may vary according to the purpose for which the AI platform is being utilized—for example, a different hardware configuration may be preferable if the AI platform is being used to provide a risk analysis to an end user or customer, whereas another embodiment may be preferable if the AI platform is being used to provide risk as part of a backend service. Furthermore, it may be possible to package the trained neural network for distribution to a client device 202 (i.e., the trained neural network may be operated on the client device 202 without the use of a server device 204).

In operation, the user of client device 202, by operating input device 222 and viewing display 224, may open input data collection application 216, which depending on the embodiment, may allow the user to enter personal information. The user may be an employee of a company controlling insurance policy computing device 104, or a customer or end user of the company. For example, input data collection application 216 may walk the user through the steps of applying for a policy, or submitting a claim.

Before the user can fully access input data collection application 216, the user may be required to authenticate (e.g., enter a valid username and password). The user may then utilize input data collection application 216. Module 212 may contain instructions that identify the user and cause input data collection application 216 to present a particular set of questions or prompts for input to the user, based upon any information input data collection application 216 collects, including without limitation information about the user or any insurable or insured asset.

Further, module 212 may identify a subset of input analysis application 260 to be used in training a neural network, and/or may indicate to server device 204 that the use of a particular neural network model or models is appropriate. For example, if the user is applying for auto insurance on a particular make and model year car, then module 212 may transmit the user's name and personal information, the location of the user as provided by GPS 218, a photograph of the vehicle to be insured captured by image sensor 220, and the make, model, and year of the vehicle to server device 204.

While FIG. 2 depicts a particular embodiment, the various components of environment 100 may interoperate in a manner that is different from that described above, and/or the environment 100 may include additional components not shown in FIG. 2. For example, an additional server/platform may act as an interface between client device 202 and server device 204, and may perform various operations associated with providing the labeling and/or elasticity analysis operations of server device 204 to client device 202 and/or other servers.

### Exemplary Artificial Neural Network

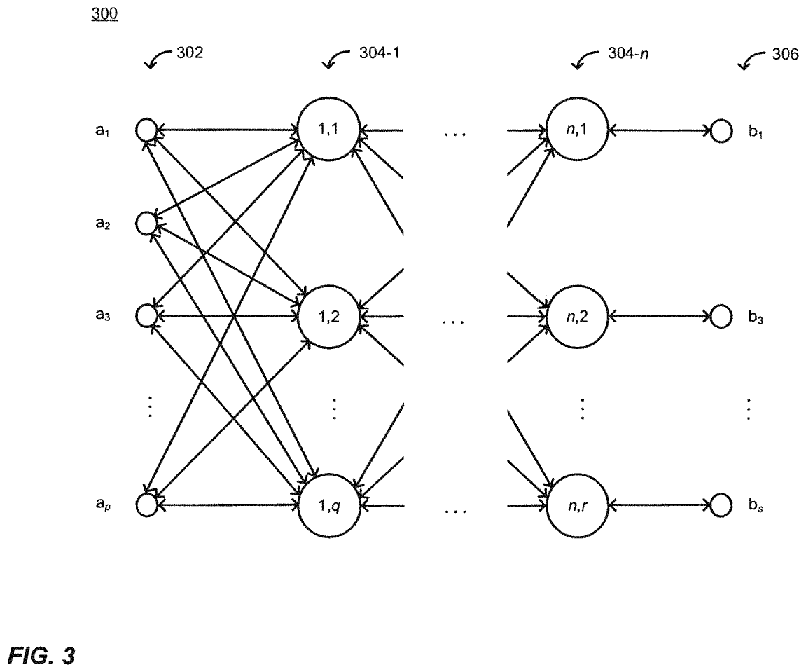

FIG. 3 depicts an exemplary artificial neural network 300 which may be trained by neural network unit 150 of FIG. 2 or neural network training application 264 of FIG. 2, according to one embodiment and scenario. The example neural network 300 may include layers of neurons, including input layer 302, one or more hidden layers 304-1 through 304-n, and output layer 306. Each layer comprising neural network 300 may include any number of neurons, i.e., q and r may be any positive integers. It should be understood that neural networks may be used to achieve the methods and systems described herein that are of a different structure and configuration than those depicted in FIG. 3.

Input layer 302 may receive different input data. Using auto insurance as an example, input layer 302 may include a first input a₁ which represents an insurance type (e.g., collision), a second input a₂ representing patterns identified in input data, a third input a₃ representing a vehicle make, a fourth input a₄ representing a vehicle model, a fifth input a₅ representing whether a claim was paid or not paid, a sixth input a₆ representing an inflation-adjusted dollar amount disbursed under a claim, and so on. Input layer 302 may comprise thousands or more inputs. In some embodiments, the number of elements used by neural network 300 may change during the training process, and some neurons may be bypassed or ignored if, for example, during execution of the neural network, they are determined to be of less relevance.

Each neuron in hidden layer(s) 304-1 through 304-n may process one or more inputs from input layer 302, and/or one or more outputs from a previous one of the hidden layers, to generate a decision or other output. Output layer 306 may include one or more outputs each indicating a label, confidence factor, and/or weight describing one or more inputs. The confidence factor and/or weight may be reflective of how strongly claim data indicates a potential or actual emerging trend or unanticipated anomaly or pattern. For instance, 0.5 may indicate one measure of elasticity, while 1.0 may indicate a higher measure of elasticity.

In some embodiments, outputs of neural network 300 may be obtained from a hidden layer 304-1 through 304-n in addition to, or in place of, output(s) from output layer(s) 306.

In some embodiments, each layer may have a discrete, recognizable, function with respect to input data. For example, if n=3, a first layer may analyze one dimension of inputs, a second layer a second dimension, and the final layer a third dimension of the inputs, where all dimensions are analyzing a distinct and unrelated aspect of the input data.

In other embodiments, the layers may not be clearly delineated in terms of the functionality they respectively perform. For example, two or more of hidden layers 304-1 through 304-n may share decisions relating to labeling, with no single layer making an independent decision as to labeling.

In some embodiments, neural network 300 may be constituted by a recurrent neural network, wherein the calculation performed at each neuron is dependent upon a previous calculation. It should be appreciated that recurrent neural networks may be more useful in performing certain tasks, such as automatic labeling of images. Therefore, in one embodiment, a recurrent neural network may be trained with respect to a specific piece of functionality with respect to environment 100 of FIG. 1. For example, in one embodiment, a recurrent neural network may be trained and utilized as part of image processing unit 124 to automatically label images.

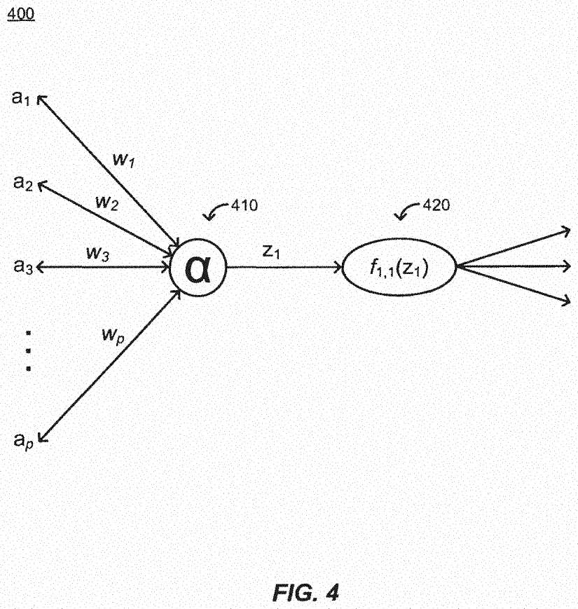

FIG. 4 depicts an example neuron 400 that may correspond to the neuron labeled as “1,1” in hidden layer 304-1 of FIG. 3, according to one embodiment. Each of the inputs to neuron 400 (e.g., the inputs comprising input layer 302) may be weighted, such that input a₁ through aₚ corresponds to weights w₁ through wₚ, as determined during the training process of neural network 300.

In some embodiments, some inputs may lack an explicit weight, or may be associated with a weight below a relevant threshold. The weights may be applied to a function α, which may be a summation and may produce a value z₁ which may be input to a function 420, labeled as ƒ_{1,1}(z₁). The function 420 may be any suitable linear or non-linear, or sigmoid, function. As depicted in FIG. 4, the function 420 may produce multiple outputs, which may be provided to neuron(s) of a subsequent layer, or used directly as an output of neural network 300. For example, the outputs may correspond to index values in a dictionary of labels, or may be calculated values used as inputs to subsequent functions.

It should be appreciated that the structure and function of the neural network 300 and neuron 400 depicted are for illustration purposes only, and that other suitable configurations may exist. For example, the output of any given neuron may depend not only on values determined by past neurons, but also future neurons.

The specific manner in which the one or more neural networks employ machine learning to label and/or quantify elasticity may differ depending on the content and arrangement of training documents within the historical data (e.g., historical insurance data 108 of FIG. 1 and input analysis application 260 of FIG. 2) and the input data provided by customers or users of the AI platform (e.g., input data 102 of FIG. 1 and the data collected by input data collection application 216 of FIG. 2), as well as the data that is joined to the historical data and input data, such as customer data 160 of FIG. 1 and customer data 272 of FIG. 2, and customer data 160 of FIG. 1 and asset data 274 of FIG. 2.

The initial structure of the neural networks (e.g., the number of neural networks, their respective types, number of layers, and neurons per layer, etc.) may also affect the manner in which the trained neural network processes the input and claims. Also, as noted above, the output produced by neural networks may be counter-intuitive and very complex.

### Unsupervised Machine Learning—Elasticity of New Business Acquisition

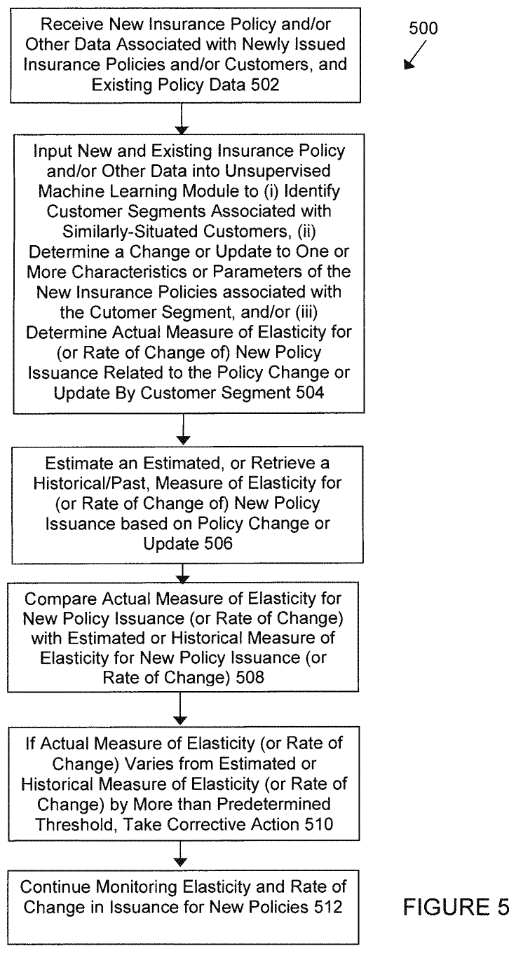

FIG. 5 depicts a computer-implemented method 500 of monitoring new business acquisition and determining elasticity (or change in demand or sales) caused by one or more changes or updates to insurance policy terms, conditions, and characteristics 504.

The method 500 may include receiving, via the one or more processors and/or associated transceivers, new insurance policy data, existing insurance policy data, and/or other data 502. The method 500 may include inputting, via the one or more processors, the new insurance policy data, existing insurance policy data, and/or other data into an unsupervised machine learning module to (i) identify customer segments within the new or existing insurance policy data associated with similarly-situated customers, (ii) determine a change or update to one or more characteristics or parameters of the new insurance policies associated with each customer segment, and/or (iIi) determine an actual measure of elasticity, or a rate of change of, new policy issuance related to, based upon, or caused by the determined policy change or update by customer segment 504.

For instance, the machine learning module may first identify customer segments within the new insurance policy data, such as customer segments associated with line of business or type of insurance, tenure, age, state or other location, credit score, employment status, marital status, etc. Additionally or alternatively, the one or more customer segments may be determined from unsupervised machine learning module analysis of mobile device and/or social media data. The new insurance policy data and/or other data may be received, gathered, or collected with customer permission or affirmative consent, such as with opt-in into a rewards, sales, or discount online program. After which, the unsupervised machine learning module may further identify an actual measure of elasticity for, or rate of change of, new policy issuance within each customer segment.

The method 500 may include estimating, via the one or more processors, an estimated measure of elasticity for, or a rate of change of, new policy issuance 506. For instance, given an identified or determined increase in an insurance discount or an identified or determined decrease in premium, an increase in new business acquisition may be estimated or predicted, such as by using or based at least in part upon historical sales and pricing data.

The method 500 may include comparing, via the one or more processors, the actual measure of elasticity for (or actual rate of change of) new policy issuance determined by the machine learning module with the estimated measure of elasticity for (or estimated rate of change of) new policy issuance for one or more customer segments 508. Additionally or alternatively, the method 500 may include determining, via the one or more processors, if the actual measure of elasticity for (or actual rate of change of) new policy issuance varies or differs from the estimated measure of elasticity (or actual rate of change of) new policy issuance by more than a predetermined threshold, such as an increase or decrease of 5, 10, or 20% as compared to policy issuance prior to the change being implemented.

If the actual elasticity varies from the estimated elasticity by more than the predetermined threshold, then the one or more processors may take corrective action 510. For instance, the one or more processors may initiate or increase discounts if policy issuance drops further than estimated. Additionally or alternatively, the one or more processors may remove the change or update to new policies being written. Additionally or alternatively, the corrective action may include adjusting the change or update in insurance policies that are being or planned to be subsequently newly issued (i) to reach a target number of new insurance policies being issued, (ii) to reach a target number of new insurance policies being issued based upon the actual measure of elasticity; or (iii) to match a desired rate of change in new policy issuance.

The method 500 may include continuing, via the one or more processors, monitoring elasticity for, and/or rate of change of, new policy issuance 512, such as by continuing to receive additional new policy data, and continuing to feed the additional new policy data into the machine learning module to identify elasticity in new policy issuance for one or more customer segments caused by the known or determined changes or updates to policy parameters, conditions, pricing, etc.

### Unsupervised Machine Learning—Elasticity of Renewal & Cancellation

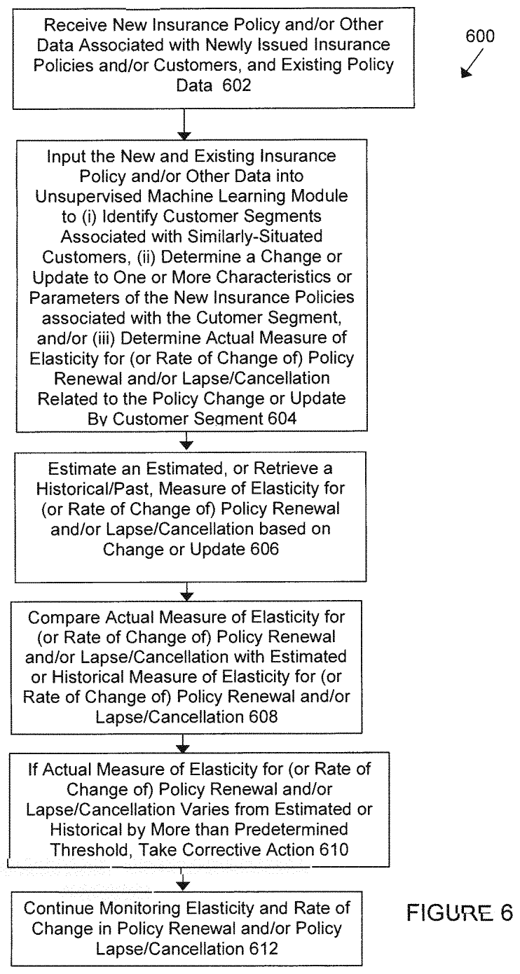

FIG. 6 depicts a computer-implemented method 600 of monitoring renewal of existing business and/or lapse/cancellation of existing business, and determining elasticity (or change in demand or sales) caused by one or more changes or updates to insurance policy terms, conditions, and characteristics 604.

The method 600 may include receiving, via the one or more processors and/or associated transceivers, new insurance policy data, existing insurance policy data, and/or other data 602. The method 600 may include inputting, via the one or more processors, the new insurance policy data, existing insurance policy data, and/or other data into an unsupervised machine learning module to (i) identify customer segments within the new or existing insurance policy data associated with similarly-situated customers, (ii) determine a change or update to one or more characteristics or parameters of the new insurance policies associated with each customer segment, and/or (iii) determine an actual measure of elasticity, or a rate of change of, policy renewal and/or lapse/cancellation related to, based upon, or caused by the determined policy change or update by customer segment 604.

For instance, the machine learning module may first identify customer segments within the new insurance policy data, such as customer segments associated with line of business or type of insurance, tenure, age, state or other location, credit score, employment status, marital status, etc. Additionally or alternatively, the one or more customer segments may be determined from unsupervised machine learning module analysis of mobile device and/or social media data. The new insurance policy data and/or other data may be received, gathered, or collected with customer permission or affirmative consent, such as with opt-in into a rewards, sales, or discount online program. After which, the unsupervised machine learning module may further identify an actual measure of elasticity for, or rate of change of, policy renewal and/or lapse/cancellation within each customer segment.

The method 600 may include estimating, via the one or more processors, an estimated measure of elasticity for, or a rate of change of, policy renewal and/or lapse/cancellation 606. For instance, given an identified or determined increase in an insurance discount or an identified or determined decrease in premium, an increase in policy renewal and/or lapse/cancellation may be estimated or predicted, such as by using or based at least in part upon historical sales and pricing data.

The method 600 may include comparing, via the one or more processors, the actual measure of elasticity for (or actual rate of change of) policy renewal and/or lapse/cancellation determined by the machine learning module with the estimated measure of elasticity for (or estimated rate of change of) policy renewal and/or lapse/cancellation for one or more customer segments 608. Additionally or alternatively, the method 600 may include determining, via the one or more processors, if the actual measure of elasticity for (or actual rate of change of), policy renewal and/or lapse/cancellation varies or differs from the estimated measure of elasticity (or actual rate of change of) policy renewal and/or lapse/cancellation by more than a predetermined threshold, such as an increase or decrease of 5, 10, or 20% as compared to policy renewal and/or lapse/cancellation prior to the change being implemented.

If the actual elasticity varies from the estimated elasticity by more than the predetermined threshold, then the one or more processors may take corrective action 610. For instance, the one or more processors may initiate or increase discounts if policy renewal drops further than estimated. Additionally or alternatively, the one or more processors may remove the change or update to new policies being written. Additionally or alternatively, the corrective action may include adjusting the change or update in insurance policies that are being or planned to be subsequently newly issued (i) to reach a target number of policy renewals and/or lapsed or cancelled policies; or (ii) to match a desired rate of change in policy renewal and/or lapse/cancellation.

The method 600 may include continuing, via the one or more processors, monitoring elasticity for, and/or rate of change of, policy renewal and/or lapse/cancellation 612, such as by continuing to receive additional new policy data, and continuing to feed the additional new policy data into the machine learning module to identify elasticity in policy renewal and/or lapse/cancellation for one or more customer segments caused by the known or determined changes or updates to policy parameters, conditions, pricing, etc.

### Supervised Machine Learning—Elasticity of New Business Acquisition

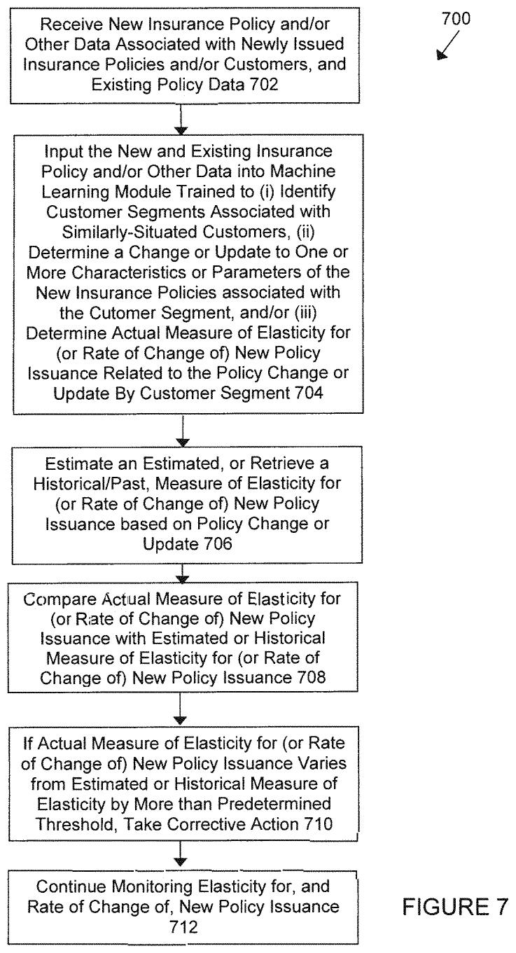

FIG. 7 depicts a computer-implemented method 700 of monitoring new business acquisition and determining elasticity (or change in demand or sales) caused by one or more changes or updates to insurance policy terms, conditions, and characteristics 704.

The method 700 may include receiving, via the one or more processors and/or associated transceivers, new insurance policy data, existing insurance policy data, and/or other data 702. The method 700 may include inputting, via the one or more processors, the new insurance policy data, existing insurance policy data, and/or other data into a machine learning module trained to (i) identify customer segments within the new or existing insurance policy data associated with similarly-situated customers, (ii) determine a change or update to one or more characteristics or parameters of the new insurance policies associated with each customer segment, and/or (iii) determine an actual measure of elasticity, or a rate of change of, new policy issuance related to, based upon, or caused by the determined policy change or update by customer segment 704.

For instance, the machine learning module may be trained to first identify customer segments within the new insurance policy data, such as customer segments associated with line of business or type of insurance, tenure, age, state or other location, credit score, employment status, marital status, etc. Additionally or alternatively, the one or more customer segments may be determined from machine learning module analysis of mobile device and/or social media data. The new insurance policy data and/or other data may be received, gathered, or collected with customer permission or affirmative consent, such as with opt-in into a rewards, sales, or discount online program. After which, the machine learning module may be trained to further identify an actual measure of elasticity for, or rate of change of, new policy issuance within each customer segment.

The method 700 may include estimating, via the one or more processors, an estimated measure of elasticity for, or a rate of change of, new policy issuance 706. For instance, given an identified or determined increase in an insurance discount or an identified or determined decrease in premium, an increase in new business acquisition may be estimated or predicted, such as by using or based at least in part upon historical sales and pricing data.

The method 700 may include comparing, via the one or more processors, the actual measure of elasticity for (or actual rate of change of) new policy issuance determined by the machine learning module with the estimated measure of elasticity for (or estimated rate of change of) new policy issuance for one or more customer segments 708. Additionally or alternatively, the method 700 may include determining, via the one or more processors, if the actual measure of elasticity for (or actual rate of change of) new policy issuance varies or differs from the estimated measure of elasticity (or actual rate of change of) new policy issuance by more than a predetermined threshold, such as an increase or decrease of 5, 10, or 20% as compared to policy issuance prior to the change being implemented.

If the actual elasticity varies from the estimated elasticity by more than the predetermined threshold, then the one or more processors may take corrective action 710. For instance, the one or more processors may initiate or increase discounts if policy issuance drops further than estimated. Additionally or alternatively, the one or more processors may remove the change or update to new policies being written. Additionally or alternatively, the corrective action may include adjusting the change or update in insurance policies that are being or planned to be subsequently newly issued (i) to reach a target number of new insurance policies being issued; (ii) to reach a target number of new insurance policies being issued based upon the actual measure of elasticity; or (iii) to match a desired rate of change in new policy issuance.

The method 700 may include continuing, via the one or more processors, monitoring elasticity for, and/or rate of change of, new policy issuance 712, such as by continuing to receive additional new policy data, and continuing to feed the additional new policy data into the machine learning module to identify elasticity in new policy issuance for one or more customer segments caused by the known or determined changes or updates to policy parameters, conditions, pricing, etc.

### Supervised Machine Learning—Elasticity of Renewal & Cancellation

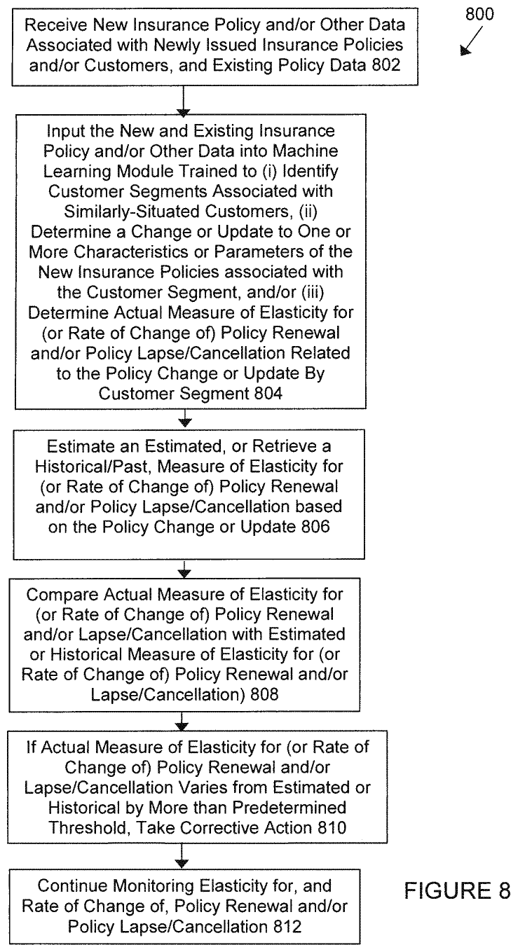

FIG. 8 depicts a computer-implemented method 800 of monitoring renewal of existing business and/or lapse/cancellation of existing business, and determining elasticity (or change in demand or sales) caused by one or more changes or updates to insurance policy terms, conditions, and characteristics 804.

The method 800 may include receiving, via the one or more processors and/or associated transceivers, new insurance policy data, existing insurance policy data, and/or other data 802. The method 800 may include inputting, via the one or more processors, the new insurance policy data, existing insurance policy data, and/or other data into a machine learning module trained to (i) identify customer segments within the new or existing insurance policy data associated with similarly-situated customers, (ii) determine a change or update to one or more characteristics or parameters of the new insurance policies associated with each customer segment, and/or (iii) determine an actual measure of elasticity, or a rate of change of, policy renewal and/or lapse/cancellation related to, based upon, or caused by the determined policy change or update by customer segment 804.

For instance, the machine learning module may be trained to first identify customer segments within the new insurance policy data, such as customer segments associated with line of business or type of insurance, tenure, age, state or other location, credit score, employment status, marital status, etc. Additionally or alternatively, the one or more customer segments may be determined from machine learning module analysis of mobile device and/or social media data. The new insurance policy data and/or other data may be received, gathered, or collected with customer permission or affirmative consent, such as with opt-in into a rewards, sales, or discount online program. After which, the machine learning module may further identify an actual measure of elasticity for, or rate of change of, policy renewal and/or lapse/cancellation within each customer segment.

The method 800 may include estimating, via the one or more processors, an estimated measure of elasticity for, or a rate of change of, policy renewal and/or lapse/cancellation 806. For instance, given an identified or determined increase in an insurance discount or an identified or determined decrease in premium, an increase in policy renewal and/or lapse/cancellation may be estimated or predicted, such as by using or based at least in part upon historical sales and pricing data.

The method 800 may include comparing, via the one or more processors, the actual measure of elasticity for (or actual rate of change of) policy renewal and/or lapse/cancellation determined by the machine learning module with the estimated measure of elasticity for (or estimated rate of change of) policy renewal and/or lapse/cancellation for one or more customer segments 808. Additionally or alternatively, the method 800 may include determining, via the one or more processors, if the actual measure of elasticity for (or actual rate of change of), policy renewal and/or lapse/cancellation varies or differs from the estimated measure of elasticity (or actual rate of change of) policy renewal and/or lapse/cancellation by more than a predetermined threshold, such as an increase or decrease of 5, 10, or 20% as compared to policy renewal and/or lapse/cancellation prior to the change being implemented.

If the actual elasticity varies from the estimated elasticity by more than the predetermined threshold, then the one or more processors may take corrective action 810. For instance, the one or more processors may initiate or increase discounts if policy renewal drops further than estimated. Additionally or alternatively, the one or more processors may remove the change or update to new policies being written. Additionally or alternatively, the corrective action may include adjusting the change or update in insurance policies that are being or planned to be subsequently newly issued (i) to reach a target number of policy renewals and/or lapsed or cancelled policies; or (ii) to match a desired rate of change in policy renewal and/or lapse/cancellation.

The method 800 may include continuing, via the one or more processors, monitoring elasticity for, and/or rate of change of, policy renewal and/or lapse/cancellation 812, such as by continuing to receive additional new policy data, and continuing to feed the additional new policy data into the machine learning module to identify elasticity in policy renewal and/or lapse/cancellation for one or more customer segments caused by the known or determined changes or updates to policy parameters, conditions, pricing, etc.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on drones, vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. For instance, machine learning may involve identifying and recognizing patterns in existing text or voice/speech data in order to facilitate making predictions for subsequent data. Voice recognition and/or word recognition techniques may also be used. Models may be created based upon example inputs in order to make valid and reliable predictions for novel inputs.

Additionally or alternatively, the machine learning programs may be trained by inputting sample data sets or certain data into the programs, such as new and existing insurance policy data, and/or other types of data, such as mobile device, drone, autonomous or semi-autonomous drone, image, vehicle telematics, smart or autonomous vehicle, vehicle-mounted or home-mounted sensor, and/or intelligent home telematics data. The machine learning programs may utilize deep learning algorithms that may be primarily focused on pattern recognition, and may be trained after processing multiple examples. The machine learning programs may include deep or combined learning, semi-supervised learning, reinforcement or reinforced learning, Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. Unsupervised anomaly detection algorithms may be used in some embodiments.

### Exemplary Unsupervised Machine Learning Techniques

The unsupervised machine learning techniques, modules, programs, and algorithms discussed herein may identify hidden structure or elasticity in unlabeled claim data. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed.

In some embodiments, the machine learning techniques described in Quantum Algorithms for Supervised and Unsupervised Machine Learning, by Seth Lloyd et al.; A Comparative Evaluation of Unsupervised Anomaly detection Algorithms for Multivariate Data, by Markus Goldstein, et al.; and Unsupervised Machine Learning, by R. Gentleman et al., which are hereby incorporated herein by reference in their entireties, may be employed.

### Unsupervised Machine Learning—Elasticity of New Business Acquisition

In one aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy, and/or new or recently issued insurance policies (such as new auto, life, or homeowners insurance policies); (2) inputting, via one or more processors, the new insurance policy data, the existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), (ii) a change or update to one or more characteristics of the new insurance policies (such as a change to, or associated with, premium, price, rate, discount, coverage, limits, conditions, deductibles, endorsements, or other parameters) within each customer segment identified, and/or (iii) an actual measure of elasticity for, or an actual rate of change of, new policy issuance (for each of the one or more customer segments) based upon, caused by, or associated with the change or update to the one or more characteristics of the new insurance policies; (3) estimating, via one or more processors, an estimated measure of elasticity for, or an estimated rate of change of, new policy issuance (for the one or more customer segments within the new insurance policies) based upon the change or update to the one or more characteristics of the new insurance policies (for the one or more customer segments within the new insurance policies), or alternatively, retrieving, via one or more processors, a historical or past measure of elasticity for, or a historical or past rate of change of, new policy issuance (for the one or more customer segments) based upon the change or update to the one or more characteristics of the new insurance policies; (4) comparing, via one or more processors, the actual measure of elasticity for, or the actual rate of change of, new policy issuance, with the estimated or historical/past measure of elasticity for, or the estimated or historical/past rate of change of new policy issuance (for the one or more customer segments), respectively; and/or (5) determining, via one or more processors, if the actual measure of elasticity, or the actual rate of change of new policy issuance, deviates from the estimated or historical/past measure of elasticity, or the estimated or historical/past rate of change of new policy issuance, respectively, by a greater than a predetermined threshold, and (6) if so, then adjusting the change or update in insurance policies that are being or planned to be subsequently newly issued (such as to minimize or reduce the impact of the change or update on new policy issuance). The method may include additional, less, or alternate actions, including those discussed elsewhere herein and directly below.

In another aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with new insurance policies that have, and/or a type of new (or newly issued) insurance policy that has, a known change to one or more characteristics of the new insurance policy (such as a known change to premium, price, rate, discount, coverage, limits, conditions, deductibles, endorsements, and/or other parameters); (2) inputting, via one or more processors, the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), and/or (ii) an actual measure of elasticity for, or an actual rate of change of, new policy issuance based upon, caused by, or associated with the known change to the one or more characteristics of the new insurance policies; (3) comparing, via one or more processors, the actual measure of elasticity of, or the actual rate of change of, new policy issuance with an estimated measure of elasticity for, or an estimated rate of change of, new policy issuance, respectively; and/or (4) determining, via one or more processors, if the actual measure of elasticity of, or the actual rate of change of, new policy issuance deviates from the estimated measure of elasticity for, or the estimated rate of change of, new policy issuance, respectively, by a greater than a predetermined threshold, and (5) if so, then adjusting the known change in insurance policies to subsequently be newly issued to facilitate reducing the impact of the change on new policy issuance. For instance, the change or an amount of the change may be having a larger than anticipated, expected, or desired impact on new policy issuance, and reducing the amount of the change may mitigate the changes impact on new policy issuance. The method, and the previous method, may include additional, less, or alternate actions, including those discussed elsewhere herein.

For instance, the method may include determining, via one or more processors, the known change to one or more characteristics of a type of new insurance policy or insurance policies that will be newly issued (such as determining a change to premium, price, rate, discount, coverage, limits, conditions, deductibles, endorsements, or other parameters), and/or estimating, via one or more processors, an estimated measure of elasticity for, or an estimated rate of change of, new policy issuance based upon the known or determined change.

The new type of insurance policy may be, or the new insurance policies may include, homeowners, auto, personal articles, life, and/or health insurance policies. The one or more customer segments within the new insurance policies associated with similarly-situated customers include one or more of: age, geographical location, state, credit score, multi-line, marital status, driving status, employment status, line of business, tenure, return customer, frequent shopper, mobile device usage, and/or type of mobile device.

The actual and estimated elasticity may be price elasticity, and the known change may be a change to premium or a discount. Additionally or alternatively, the actual and estimated elasticity may be elasticity with respect to, or elasticity associated with, tied to, or based upon, insurance product characteristics, coverages, limits, conditions, endorsements, or other insurance contract parameters. The known or determined change may be a change to a coverage, limit, condition, deductible, endorsement, and/or other insurance contract parameter.

The new insurance policy data and/or other data may include mobile device, social media, and/or online purchasing data. The new insurance policy data and/or other data may be received, gathered, and/or collected with customer permission or affirmative consent, such as with opt-in into a rewards, sales, or discount online program. Additionally or alternatively, the insurance policy data and/or other data may include website, browsing history, online quote request, and/or websites visited or frequented data, and the new insurance policy data and/or other data may be received, gathered, or collected with customer permission or affirmative consent, such as with opt-in into a rewards, sales, or discount online program. The one or more customer segments may be determined from processor or machine learning module analysis of mobile device and/or social media data, and the new insurance policy and/or other data may be received, gathered, or collected with customer permission or affirmative consent, such as with opt-in into a rewards, sales, or discount online program.

Adjusting the change or update in insurance policies that are being or planned to be subsequently newly issued may include adjusting the change or update to the new insurance policies (i) to reach a target number of new insurance policies being issued, (ii) to reach a target number of new insurance policies being issued based upon the actual measure of elasticity; or (iii) to match a desired rate of change in new policy issuance.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other data, the new insurance policy data including data in several data fields, the new insurance policy data associated with a type of new (or newly issued) insurance policy, and/or new insurance policies (such as new insurance policies from a given line of business, such as auto or homeowners insurance); (2) input the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), (ii) a change or update to one or more characteristics of the new insurance policies (such as a change to, or associated with, premium, price, rate, discount, coverage, limits, conditions, deductibles, endorsements, or other parameters) within each customer segment identified, and/or (iii) an actual measure of elasticity for, or an actual rate of change of, new policy issuance (for the one or more customer segments within the new insurance policies) based upon, caused by, or associated with the change or update to the one or more characteristics of the new insurance policies; (3) estimate an estimated measure of elasticity for, or an estimated rate of change of, new policy issuance (for the one or more customer segments within the new insurance policies) based upon the change or update to the one or more characteristics of the new insurance policies, or alternatively, retrieving, via one or more processors, a historical or past measure of elasticity for, or a historical or past rate of change of, new policy issuance (for the one or more customer segments) based upon the change or update to the one or more characteristics of the new insurance policies; (4) compare the actual measure of elasticity for, or the actual rate of change of, new policy issuance, with the estimated or historical/past measure of elasticity for, or the estimated or historical/past rate of change of, new policy issuance (for the one or more customer segments), respectively; and/or (5) determine if the actual measure of elasticity for, or the actual rate of change of, new policy issuance, deviates from the estimated or historical/past measure of elasticity for, or the estimated or historical/past rate of change of, new policy issuance, respectively, by a greater than a predetermined threshold, and if so, adjusting the change or update in insurance policies that are being or planned to be subsequently newly issued (such as to reduce or minimize the impact of the change or update on new policy issuance). The computer system may include additional, less, or alternate functionality, including that discussed elsewhere herein.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The system may include one or more processors and/or associated transceivers configured to: (1) receive new insurance policy data, existing insurance policy data, and/or other data, the new insurance policy data including data in several data fields, and the new insurance policy data associated with new insurance policies having, and/or a type of new (or newly issued) insurance policy that has, a known change to one or more characteristics of the new insurance policy (such as a known change to premium, price, rate, discount, coverage, limits, conditions, deductibles, endorsements, and/or other parameters); (2) input the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), and/or (ii) an actual measure of elasticity for, or an actual rate of change of, new policy issuance based upon, caused by, or associated with the known change to the one or more characteristics of the new insurance policy; (3) compare the actual measure of elasticity for, or the actual rate of change of, new policy issuance with an estimated measure of elasticity for, or the estimated rate of change of, new policy issuance, respectively; and/or (4) determine if the actual measure of elasticity for, or the actual rate of change of, new policy issuance deviates from the estimated measure of elasticity for, or the estimated rate of change of, new policy issuance, respectively, by a greater than a predetermined threshold, and (5) if so, then adjusting the known change in insurance policies to subsequently be newly issued to minimize or reduce the impact of the change on new policy issuance.

The one or more processors may be further configured to: determine the known change to one or more characteristics of a type of new insurance policy or new insurance policies that will be newly issued (such as determine an actual change to premium, price, rate, discount, coverage, limits, conditions, deductibles, endorsements, and/or other parameters); and/or estimate an estimated measure of elasticity for, or an estimated rate of change of new policy issuance based upon the known change. The computer system may include additional, less, or alternate functionality, including that discussed elsewhere herein.

### Unsupervised Machine Learning—Elasticity of Renewal/Cancellation

In another aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing policy data, and/or other data, the new insurance policy data including data in several data fields, the new insurance policy data associated with a type of new (or newly issued) insurance policy, and/or new insurance policies; (2) inputting, via one or more processors, the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), (ii) a change or update to one or more characteristics of the new insurance policies (such as a change to premium, price, rate, discount, coverage, limits, conditions, deductibles, endorsements, and/or other parameters) within each customer segment identified, and/or (iii) an actual measure of elasticity for, or an actual rate of change of, policy renewal and/or policy lapse/cancellation (for the one or more customer segments) based upon, caused by, or associated with the change or update to the one or more characteristics of the new insurance policies; (3) estimating, via one or more processors, an estimated measure of elasticity for, or an estimated rate of change of, policy renewal and/or policy lapse/cancellation (for the one or more customer segments) based upon the change or update to the one or more characteristics of the new insurance policies, or alternatively, retrieving, via one or more processors, a historical or past measure of elasticity for, or a historical or past rate of change of, policy renewal and/or policy lapse/cancellation (for the one or more customer segments) based upon the change or update to the one or more characteristics of the new insurance policies; (4) comparing, via one or more processors, the actual measure of elasticity for, or the actual rate of change of, policy renewal and/or policy lapse/cancellation, with the estimated or historical/past measure of elasticity for, or the estimated or historical/past rate of change of, policy renewal and/or lapse/cancellation (for the one or more customer segments), respectively; and/or (5) determining, via one or more processors, if the actual measure of elasticity, or the actual rate of change of, policy renewal and/or lapse/cancellation deviates from the estimated or historical/past measure of elasticity, or the estimated or historical/past rate of change of, policy renewal and/or lapse/cancellation, respectively, by a greater than a predetermined threshold, and (6) if so, then adjusting the change or update in insurance policies that are being or planned to be subsequently newly issued (such as to facilitating reducing the impact of the change or update on policy renewal and/or policy lapse/cancellation). The method may include additional, less, or alternate actions, including those discussed elsewhere herein.

In another aspect, a computer-implemented method of determining price or other elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with new insurance policies that have, and/or a type of new (or newly issued) insurance policy that has, a known change to one or more characteristics of the new insurance policy (such as a known change to premium, price, rate, discount, coverage, limits, conditions, deductibles, endorsements, and/or other insurance contract parameters); (2) inputting, via one or more processors, the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), and/or (ii) an actual measure of elasticity for, or an actual rate of change of, policy renewal and/or lapse/cancellation based upon, caused by, or associated with the known change to the one or more characteristics of the new insurance policies; (3) comparing, via one or more processors, the actual measure of elasticity for, or the actual rate of change of, policy renewal and/or lapse/cancellation with an estimated measure of elasticity for, or an estimated rate of, change of policy renewal and/or lapse/cancellation, respectively; and/or (4) determining, via one or more processors, if the actual measure of elasticity for, or the actual measure of rate of change of, policy renewal and/or lapse/cancellation deviates from the estimated measure of elasticity or the estimated rate of change of, new policy issuance, respectively, by a greater than a predetermined threshold, and (5) if so, then adjusting the known change in insurance policies to subsequently be newly issued to reduce or minimize the impact of the change on policy renewal and/or lapse/cancellation. The method, and the method mentioned previously above, may include additional, less, or alternate actions, including those discussed elsewhere herein.

For instance, the method may include determining, via one or more processors, the known change to one or more characteristics of a type of new insurance policy or of new insurance policies that will be newly issued (such as determining a change to premium, price, rate, discount, coverage, limits, conditions, deductibles, endorsements, and/or other parameters); and/or estimating, via one or more processors, an estimated measure of elasticity for, or an estimated rate of change of, policy renewal and/or policy lapse/cancellation based upon the known change.

The type of new insurance policy may be, or the new insurance policies may include, homeowners, auto, personal articles, life, health, commercial, workers compensation, disability, and/or other types of insurance policies. The one or more customer segments associated with similarly-situated customers may include one or more of: age, geographical location, state, credit score, multi-line, marital status, driving status, employment status, line of business, tenure, return customer, frequent shopper, mobile device usage, and/or type of mobile device.

The actual and estimated elasticity may be price elasticity, and the known change may be a change to premium or a discount. Additionally or alternatively, the actual and estimated elasticity may be elasticity with respect to, associated with, or based at least in part on, insurance product characteristics, coverages, deductibles, conditions, endorsements, limits, and/or other insurance contract parameters or variables. The known change may be a change to a coverage, limit, condition, deductible, endorsement, and/or other insurance contract parameter or variable.

The new insurance policy data and/or other data may include mobile device, social media, and/or online purchasing data, and the new insurance policy and/or other data may be received, gathered, and/or collected with customer permission or affirmative consent, such as with opt-in into a rewards, sales, or discount online program. Additionally or alternatively, the insurance policy data and/or other data may include website, browsing history, online quote request, and/or websites visited or frequented data, and the new insurance policy data and/or other data may be received, gathered, and/or collected with customer permission or affirmative consent, such as with opt-in into a rewards, sales, or discount online program. The one or more customer segments may be determined from processor or machine learning module analysis of mobile device and/or social media data, and the new insurance policy and/or other data may be received, gathered, and/or collected with customer permission or affirmative consent, such as with opt-in into a rewards, sales, or discount online program.

Adjusting the change or update in insurance policies that are being or planned to be subsequently newly issued may include adjusting the change or update to the new insurance policies (i) to reach a target number of policy renewals, (ii) to reach a target number of lapsed and/or cancelled policies, or (iii) to match a desired rate of change in policy renewal, and/or policy lapse and/or cancellation.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The computer system including one or more processors and/or associated transceivers configured to: (1) receive new insurance policy data, existing insurance policy data, and/or other data, the new insurance policy data including data in several data fields, the new insurance policy data associated with a type of new (or newly issued) insurance policy, and/or new insurance policies; (2) input the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies that are associated with similarly-situated customers (such as by analysis of the several data fields), (ii) a change or update to one or more characteristics of the new insurance policies (such as a change to premium, price, rate, discount, coverage, limits, conditions, deductibles, endorsements, and/or other parameters) within each customer segment identified, and/or (iii) an actual measure of elasticity for, or an actual rate of change of, policy renewal and/or lapse/cancellation (for the one or more customer segments) based upon, caused by, or associated with the change or update to the one or more characteristics of the new insurance policies; (3) estimate an estimated measure of elasticity for, or an estimated rate of change of, policy renewal and/or lapse/cancellation (for the one or more customer segments) based upon the change or update to the one or more characteristics of the new insurance policies, or alternatively, retrieving, via one or more processors, a historical or past measure of elasticity for, or a historical or past rate of change of, policy renewal and/or lapse/cancellation (for the one or more customer segments) based upon the change or update to the one or more characteristics of the new insurance policies; (4) compare the actual measure of elasticity for, or the actual rate of change of, policy renewal and/or lapse/cancellation with the estimated or historical/past measure of elasticity for, or the estimated or historical/past rate of change of, policy renewal and/or lapse/cancellation (for the one or more customer segments), respectively; and/or (5) determine if the actual measure of elasticity for, or the actual rate of change of, policy renewal and/or lapse/cancellation deviates from the estimated or historical/past measure of elasticity for, or the estimated or historical/past rate of change of, policy renewal and/or lapse/cancellation, respectively, by a greater than a predetermined threshold, and (6) if so, adjusting the change or update in insurance policies that are being or planned to be subsequently newly issued to facilitate reducing or minimizing the impact of the change or update on policy renewal and/or policy lapse/cancellation. The computer system may include additional, less, or alternate functionality, including that discussed elsewhere herein.

In another aspect, a computer system configured to determine price or other elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other date, the new insurance policy data including data in several data fields, the new insurance policy data and/or other data associated with a type of new (or newly issued) insurance policy that has, and/or new insurance policies that all have, a known change to one or more characteristics of the new insurance policies (such as a known change to premium, price, rate, discount, coverage, limits, conditions, deductibles, endorsements, and/or other insurance contract or insurance-related parameters or variables); (2) input the new insurance policy data, existing insurance policy data, and/or other data into an unsupervised machine learning model, program, module, or algorithm (such as an unsupervised machine learning anomaly detection model, program, module, or algorithm) to identify, determine, or detect (i) one or more customer segments within the new insurance policies associated with similarly-situated customers (such as by analysis of the several data fields), and/or (ii) an actual measure of elasticity for, or an actual rate of change of, policy renewal and/or lapse/cancellation based upon, caused by, or associated with the known change to the one or more characteristics of the new insurance policies; (3) compare the actual measure of elasticity for, or the actual rate of change of, policy renewal and/or lapse/cancellation with an estimated measure of elasticity for, or an estimated rate of change of, policy renewal and/or lapse/cancellation, respectively; and/or (4) determine if the actual measure of elasticity for, or the actual rate of change of, policy renewal and/or lapse/cancellation deviates from the estimated measure of elasticity for, or the estimated rate of change of, new policy issuance, respectively, by a greater than a predetermined threshold, and (5) if so, then adjusting the known change in insurance policies to subsequently be newly issued to reduce or minimize the impact of the change on policy renewal and/or policy lapse/cancellation.

The one or more processors may further be configured to: determine the known change to one or more characteristics of a type of new insurance policy or new insurance policies that will be newly issued (such as determine a change to premium, price, rate, discount, coverage, limits, conditions, deductibles, endorsements, and/or other insurance-related parameters in new insurance policies); and/or estimate an estimated measure of elasticity for, or an estimated rate of change of, policy renewal and/or lapse/cancellation based upon the known change. The computer system may include additional, less, or alternate functionality, including that discussed elsewhere herein.

### Supervised Machine Learning—Elasticity of New Business Acquisition

In one aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy, and/or new insurance policies; (2) inputting, via one or more processors, the new insurance policy data, existing insurance policy data, and/or other data into a machine learning model, program, module, or algorithm trained to identify, determine, or detect (i) one or more customer segments within the new insurance policies that are associated with similarly-situated customers (such as by analysis of the several data fields), (ii) a change or update to one or more characteristics of the new insurance policies (such as a change to, or associated with, premium, price, rate, discount, coverage, limits, conditions, deductibles, endorsements, and/or other parameters) within each customer segment identified, and/or (iii) an actual measure of elasticity for, or an actual rate of change of, new policy issuance (for the one or more customer segments of new insurance policies) based upon, caused by, or associated with the change or update to the one or more characteristics of the new insurance policies; (3) estimating, via one or more processors, an estimated measure of elasticity for, or an estimated rate of change of, new policy issuance (for the one or more customer segments) based upon the change or update to the one or more characteristics of the new insurance policies, or alternatively, retrieving, via one or more processors, a historical or past measure of elasticity for, or a historical or past rate of change of, new policy issuance (for the one or more customer segments) based upon the change or update to the one or more characteristics of the new insurance policies; (4) comparing, via one or more processors, the actual measure of elasticity for, or the actual rate of change of, new policy issuance with the estimated or historical/past measure of elasticity for, or the estimated or historical/past rate of change of, new policy issuance (for the one or more customer segments), respectively; and/or (5) determining, via one or more processors, if the actual measure of elasticity for, or the actual rate of change of, new policy issuance deviates from the estimated or historical/past measure of elasticity for, or the estimated or historical/past rate of change of, new policy issuance, respectively, by a greater than a predetermined threshold, and (6) if so, then adjusting the change or update in insurance policies that are being or planned to be subsequently newly issued to facilitate reducing or minimizing the impact of the change or update on new policy issuance. The method may include additional, less, or alternate actions, including those discussed elsewhere herein.

In another aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy that has, or new insurance policies that have, a known change to one or more characteristics of the new insurance policies (such as a known change to premium, price, rate, discount, coverage, limits, conditions, deductibles, endorsements, and/or other insurance contract or insurance-related parameters or variables); (2) inputting, via one or more processors, the new insurance policy data, existing insurance policy data, and/or other data into a machine learning model, program, module, or algorithm trained to identify or detect (i) one or more customer segments within the new insurance policies associated with similarly-situated customers (such as by analysis of the several data fields), and/or (ii) an actual measure of elasticity for, or an actual rate of change of new policy issuance based upon, caused by, or associated with the known change to the one or more characteristics of the new insurance policies; (3) comparing, via one or more processors, the actual measure of elasticity for, or the actual rate of change of, new policy issuance with an estimated measure of elasticity for, or an estimated rate of change of, new policy issuance, respectively; and/or (4) determining, via one or more processors, if the actual measure of elasticity for, or the actual rate of change of, new policy issuance deviates from the estimated measure of elasticity for, or the estimated rate of change of, new policy issuance, respectively, by a greater than a predetermined threshold, and (5) if so, then adjusting the known change in insurance policies to subsequently be newly issued to reduce or minimize the impact of the change on new policy issuance. The method, and the foregoing method, may include additional, less, or alternate actions, including those discussed elsewhere herein.

For instance, the method may include (1) determining, via one or more processors, the known change to one or more characteristics of a type of new insurance policy, or new insurance policies that will be newly issued (such as determining a change to premium, price, rate, discount, coverage, limits, conditions, deductibles, endorsements, and/or other insurance-related parameters or variables); and/or (2) estimating, via one or more processors, an estimated measure of elasticity for, or an estimated rate of change of, new policy issuance based upon the known or determined change.

The type of insurance policy may be, and the new insurance policies may include, homeowners, auto, personal articles, life, health, and/or other types of insurance policies. The one or more customer segments associated with similarly-situated customers may include one or more of: age, geographical location, state, credit score, multi-line, marital status, driving status, employment status, line of business, tenure, return customer, frequent shopper, mobile device usage, and/or type of mobile device.

The actual and estimated elasticity may be price elasticity, and the known change may be a change to premium or a discount. Additionally or alternatively, the actual and estimated elasticity may be elasticity with respect to, associated with, or based at least in part upon, one or more insurance product characteristics, coverages, limits, conditions, endorsements, deductibles, and/or other insurance contract parameters or variables. The known change may be a change to a coverage, limit, condition, deductible, endorsement, and/or other parameter.

The new insurance policy data and/or other data may include mobile device, social media, and/or online purchasing data, and the new insurance policy data and/or other data may be received, gathered, and/or collected with customer permission or affirmative consent, such as with opt-in into a rewards, sales, or discount online program. Additionally or alternatively, the insurance policy data and/or other data may include website, browsing history, online quote request, and/or websites visited or frequented data, and the new insurance policy data and/or other data may be received, gathered, or collected with customer permission or affirmative consent, such as with opt-in into a rewards, sales, or discount online program. The one or more customer segments may be determined from processor or machine learning module analysis of mobile device and/or social media data, and/or the new insurance policy and/or other data (such as mobile device or social media data) may be received, gathered, or collected with customer permission or affirmative consent, such as with opt-in into a rewards, sales, or discount online program.

Adjusting the change or update in insurance policies that are being or planned to be subsequently newly issued may include adjusting the change or update to the new insurance policies (i) to reach a target number of new insurance policies being issued, (ii) to reach a target number of new insurance policies being issued based upon the actual measure of elasticity; or (iii) to match a desired rate of change in new policy issuance.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other data, the new insurance policy data including data in several data fields, the new insurance policy data associated with a type of new (or newly issued) insurance policy, and/or new insurance policies; (2) input the new insurance policy data, existing insurance policy data, and/or other data into a machine learning model, program, module, or algorithm trained to identify, determine, or detect (i) one or more customer segments within the new insurance policies associated with similarly-situated customers (such as by analysis of the several data fields), (ii) a change or update to one or more characteristics of the new insurance policy or policies (such as a change to premium, price, rate, discount, coverage, limits, conditions, deductibles, endorsements, and/or other parameters) within each customer segment identified, and/or (iii) an actual measure of elasticity for, or an actual rate of change of, new policy issuance (for the one or more customer segments of new insurance policies) based upon, caused by, or associated with the change or update to the one or more characteristics of the new insurance policies; (3) estimate an estimated measure of elasticity for, or an estimated rate of change of, new policy issuance (for the one or more customer segments) based upon the change or update to the one or more characteristics of the new insurance policies, or alternatively, retrieving, via one or more processors, a historical or past measure of elasticity for, or a historical or past rate of change of, new policy issuance (for the one or more customer segments) based upon the change or update to the one or more characteristics of the new insurance policies; (4) compare the actual measure of elasticity for, or the actual rate of change of, new policy issuance with the estimated or historical/past measure of elasticity for, or the estimated or historical/past rate of change of, new policy issuance (for the one or more customer segments), respectively; and/or (5) determine if the actual measure of elasticity for, or the actual rate of change of, new policy issuance deviates from the estimated or historical/past measure of elasticity for, or the estimated or historical/past rate of change of, new policy issuance, respectively, by a greater than a predetermined threshold, and (6) if so, then adjusting the change or update in insurance policies that are being or planned to be subsequently newly issued to facilitating reducing or minimizing the impact of the change or update on new policy issuance. The computer system may include additional, less, or alternate functionality, including that discussed elsewhere herein.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other data, the new insurance policy data and/or other data including data in several data fields, the new insurance policy data associated with a type of new (or newly issued) insurance policy that has, and/or new insurance policies that all have, a known change to one or more characteristics of the new insurance policy (such as a known change to premium, price, rate, discount, coverage, limits, conditions, deductibles, endorsements, and/or other insurance contract parameters or variables); (2) input the new insurance policy data, existing insurance policy data, and/or other data into a machine learning model, program, module, or algorithm trained to identify, determine, or detect (i) one or more customer segments within the new insurance policies associated with similarly-situated customers (such as by analysis of the several data fields), and/or (ii) an actual measure of elasticity for, or an actual rate of change of, new policy issuance based upon, caused by, or associated with the known change to the one or more characteristics of the new insurance policies; (3) compare the actual measure of elasticity for, or the actual rate of change of, new policy issuance with an estimated measure of elasticity for, or the estimated rate of change of, new policy issuance, respectively; and/or (4) determine if the actual measure of elasticity of, or the actual rate of change of, new policy issuance deviates from the estimated measure of elasticity for, or the estimated rate of change of, new policy issuance, respectively, by a greater than a predetermined threshold, and (5) if so, then adjusting the known change in insurance policies to subsequently be newly issued to reduce the impact of the change on new policy issuance.

For instance, the impact of the change on new policy issuance may be greater than desired or expected, and reducing the amount of the change may alleviate the total impact of the change on new policy issuance. The one or more processors may further be configured to: determine the known change to one or more characteristics of a type of new insurance policy or new insurance policies that will be newly issued (such as determine an actual change to premium, price, rate, discount, coverage, limits, conditions, deductibles, endorsements, and/or other insurance contract parameters or variables); and/or estimate an estimated measure of elasticity for, or an estimated rate of change of, new policy issuance based upon the known change. The computer system may be configured to have additional, less, or alternate functionality, including that discussed elsewhere herein.

### Supervised Machine Learning—Elasticity of Renewal/Cancellation

In another aspect, a computer-implemented method of determining (price or other) elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy, and/or new insurance policies (such as new insurance policies of the same type, such as new auto insurance policies); (2) inputting, via one or more processors, the new insurance policy data, existing insurance policy data, and/or other data into a machine learning model, program, module, or algorithm trained to identify, determine, or detect (i) one or more customer segments associated with similarly-situated customers within, or of, the new insurance policies (such as by analysis of the several data fields), (ii) a change or update to one or more characteristics of the new insurance policies (such as a change to, or associated with, premium, price, rate, discount, coverage, limits, conditions, deductibles, endorsements, and/or other parameters) within each customer segment identified, and/or (iii) an actual measure of elasticity for, or an actual rate of change of, policy renewal and/or policy lapse/cancellation (for the one or more customer segments) based upon, caused by, or associated with the change or update to the one or more characteristics of the new insurance policies; (3) estimating, via one or more processors, an estimated measure of elasticity for, or an estimated rate of change of, policy renewal and/or policy lapse/cancellation (for the one or more customer segments of the new insurance policies) based upon the change or update to the one or more characteristics of the new insurance policies, or alternatively, retrieving, via one or more processors, a historical or past measure of elasticity for, or a historical or past rate of change of, policy renewal and/or lapse/cancellation (for the one or more customer segments) based upon the change or update to the one or more characteristics of the new insurance policies; (4) comparing, via one or more processors, the actual measure of elasticity for, or the actual rate of change of, policy renewal and/or policy lapse/cancellation with the estimated or historical/past measure of elasticity for, or the estimated or historical/past rate of change of, policy renewal and/or lapse/cancellation (for the one or more customer segments) for the new insurance policies, respectively; and/or (5) determining, via one or more processors, if the actual measure of elasticity for, or the actual rate of change of, policy renewal and/or lapse/cancellation deviates from the estimated or historical/past measure of elasticity for, or the estimated or historical/past rate of change of, policy renewal and/or lapse/cancellation, respectively, by a greater than a predetermined threshold, and (6) if so, then adjusting the change or update in insurance policies that are being or planned to be subsequently newly issued to facilitate reducing the impact of the change or update on policy renewal and/or policy lapse/cancellation. The method may include additional, less, or alternate actions, including those discussed elsewhere herein.

In another aspect, a computer-implemented method of determining price elasticity for insurance policies from analyzing renewal, lapse, cancellation, sales, existing or new policy, mobile device, website, browsing, online purchasing, social media, and/or other data may be provided. The method may include (1) receiving, via one or more processors and/or associated transceivers, new insurance policy data, existing insurance policy data, and/or other data, the new insurance policy data including data in several data fields, the new insurance policy data associated with a type of new (or newly issued) insurance policy that has, and/or new insurance policies that all have, a known change to one or more characteristics of the new insurance policies (such as the known change to premium, price, rate, discount, coverage, limits, conditions, deductibles, endorsements, or other insurance-related parameters or variables); (2) inputting, via one or more processors, the new insurance policy data, existing insurance policy data, and/or other data into a machine learning model, program, module, or algorithm trained to identify, determine, or detect (i) one or more customer segments associated with similarly-situated customers (such as by analysis of the several data fields), and/or (ii) an actual measure of elasticity for, or an actual rate of change of, policy renewal and/or lapse/cancellation based upon, caused by, or associated with the known change to the one or more characteristics of the new insurance policies; (3) comparing, via one or more processors, the actual measure of elasticity for, or the actual rate of change of, policy renewal and/or lapse/cancellation with an estimated measure of elasticity for, or an estimated rate of change of, policy renewal and/or lapse/cancellation, respectively; and/or (4) determining, via one or more processors, if the actual measure of elasticity for, or the actual rate of change of, policy renewal and/or lapse/cancellation deviates from the estimated measure of elasticity for, or the estimated rate of change of, new policy issuance, respectively, by a greater than a predetermined threshold, and (5) if so, then adjusting the known change in insurance policies to subsequently be issued to reduce the size of the impact of the change on policy renewal and/or lapse/cancellation. The method may include additional, less, or alternate actions, including those discussed elsewhere herein.

For instance, the method may include determining, via one or more processors, the known change to one or more characteristics of a type of new insurance policy, or of new insurance policies that will be newly issued (such as determining a change to premium, price, rate, discount, coverage, limits, conditions, deductibles, endorsements, and/or other insurance-related variables or parameters); and/or estimating, via one or more processors, an estimated measure of elasticity for, or an estimated rate of change of, policy renewal and/or lapse/cancellation based at least in part upon the known change.

The type of insurance policy or the new insurance policies may include homeowners, auto, personal articles, life, health, and/or other types of insurance policies. The one or more customer segments associated with similarly-situated customers may include one or more of: age, geographical location, state, credit score, multi-line, marital status, driving status, employment status, line of business, tenure, return customer, frequent shopper, mobile device usage, and/or type of mobile device.

The actual and estimated elasticity may be price elasticity, and the known change may be a change to premium or a discount. The actual and estimated elasticity may be elasticity with respect to, associated with, or based upon insurance product characteristics, coverages, limits, deductibles, conditions, endorsements, and/or other insurance-related parameters or variables. The known change may be a change to a coverage, limit, condition, deductible, endorsement, or other insurance-related parameter or variable.

The new insurance policy data and/or other data may include mobile device, social media, and/or online purchasing data, and the new insurance policy data and/or other data may be received, gathered, or collected with customer permission or affirmative consent, such as with opt-in into a rewards, sales, or discount online program. Additionally or alternatively, the insurance policy data and/or other data may include website, browsing history, online quote request, and/or websites visited or frequented data, and the new insurance policy data and/or other data may be received, gathered, or collected with customer permission or affirmative consent, such as with opt-in into a rewards, sales, or discount online program. The one or more customer segments may be determined from processor or machine learning module analysis of mobile device and/or social media data, and the new insurance policy data and/or other data may be received, gathered, or collected with customer permission or affirmative consent, such as with opt-in into a rewards, sales, or discount online program.

Adjusting the change or update in insurance policies that are being or planned to be subsequently newly issued may include adjusting the change or update to the new insurance policies (i) to reach a target number of policy renewals, (ii) to reach a target number of lapsed and/or cancelled policies, or (iii) to match a desired rate of change in policy renewal, and/or policy lapse and/or cancellation.

In another aspect, a computer system configured to determine (price or other) elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other data, the new insurance policy data including data in several data fields, the new insurance policy data associated with a type of new (or newly issued) insurance policy, and/or new insurance policies (such as new insurance policies of a same type, such as homeowners, auto, life, or health insurance); (2) input the new insurance policy data, existing insurance policy data, and/or other data into a machine learning model, program, module, or algorithm trained to identify, determine, or detect (i) one or more customer segments within the new insurance policies associated with similarly-situated customers (such as by analysis of the several data fields), (ii) a change or update to one or more characteristics of the new insurance policies (such as a change to premium, price, rate, discount, coverage, limits, conditions, deductibles, endorsements, and/or other parameters) within each customer segment identified, and/or (iii) an actual measure of elasticity for, or an actual rate of change of, policy renewal and/or policy lapse/cancellation (for the one or more customer segments) based upon, caused by, or associated with the change or update to the one or more characteristics of the new insurance policy or policies; (3) estimate an estimated measure of elasticity for, or an estimated rate of change of, policy renewal and/or policy lapse/cancellation (for the one or more customer segments) based upon the change or update to the one or more characteristics of the new insurance policy or policies, or alternatively, retrieving, via one or more processors, a historical or past measure of elasticity for, or a historical or past rate of change of, policy renewal and/or policy lapse and/or cancellation (for the one or more customer segments) based upon the change or update to the one or more characteristics of the new insurance policy or policies; (4) compare the actual measure of elasticity for, or the actual rate of change of, policy renewal and/or policy lapse/cancellation with the estimated or historical/past measure of elasticity for, or the estimated or historical/past rate of change of, policy renewal and/or policy lapse/cancellation (for the one or more customer segments), respectively; and/or (5) determine if the actual measure of elasticity for, or the actual rate of change of, policy renewal and/or policy lapse/cancellation deviates from the estimated or historical/past measure of elasticity for, or the estimated or historical/past rate of change of, policy renewal and/or policy lapse/cancellation, respectively, by a greater than a predetermined threshold, and (6) if so, then adjusting the change or update in insurance policies that are being or planned to be subsequently newly issued to facilitate reducing the impact of the change or update on policy renewal and/or policy lapse/cancellation. The computer system may include additional, less, or alternate functionality, including that discussed elsewhere herein.

In another aspect, a computer system configured to determine price or other elasticity for insurance policies from analyzing renewal, lapse, cancellation, sales, existing or new policy, mobile device, website, browsing, online purchasing, social media, and/or other data may be provided. The computer system may include one or more processors and/or associated transceivers configured to: (1) receive new insurance policy data, existing insurance policy data, and/or other data, the new insurance policy data including data in several data fields, the new insurance policy data associated with a type of new (or newly issued) insurance policy that has, and/or new insurance policies that all have, a known change to one or more characteristics of the new insurance policy (such as the known change to premium, price, rate, discount, coverage, limits, conditions, deductibles, endorsements, and/or other insurance-related variables or contract parameters); (2) input the new insurance policy data, existing insurance policy data, and/or other data into a machine learning model, program, module, or algorithm trained to identify, determine, or detect (i) one or more customer segments within the new insurance policies associated with similarly-situated customers (such as by analysis of the several data fields), and/or (ii) an actual measure of elasticity for, or an actual rate of change of policy renewal and/or lapse/cancellation (for the one or more customer segments) based upon, caused by, or associated with the known change to the one or more characteristics of the new insurance policy; (3) compare the actual measure of elasticity for, or the actual rate of change of, policy renewal and/or lapse/cancellation (for the one or more customer segments) with an estimated measure of elasticity for, or an estimated rate of change of, policy renewal and/or cancellation, respectively; and/or (4) determine if the actual measure of elasticity for, or the actual rate of change of, policy renewal and/or lapse/cancellation deviates from the estimated measure of elasticity for, or the estimated rate of change of, new policy issuance, respectively, by a greater than a predetermined threshold; and (5) and if so, then adjusting the known change in insurance policies to subsequently be newly issued to reduce the impact of the change on policy renewal and/or policy lapse/cancellation.

The one or more processors may be further configured to: determine the known change to one or more characteristics of a type of new insurance policy, and/or the new insurance policies that will be newly issued (such as determine an actual change to premium, price, rate, discount, coverage, limits, conditions, deductibles, endorsements, and/or other insurance contract parameters or variables); and estimate an estimated measure of elasticity for, or an estimated rate of change of, policy renewal and/or lapse/cancellation (for one or more customer segments) based upon the known change. The computer system may include additional, less, or alternate functionality, including that discussed elsewhere herein.

### Supervised Machine Learning—Elasticity of New Business Acquisition

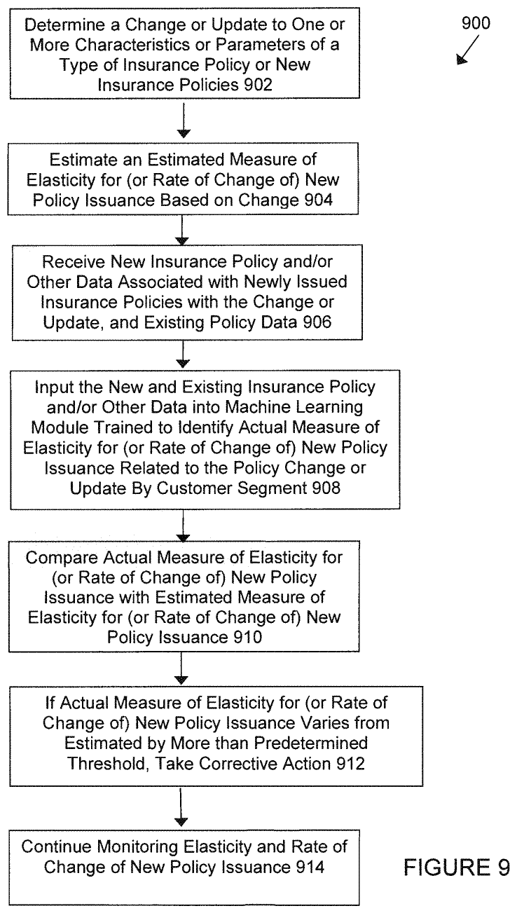

FIG. 9 depicts a computer-implemented method 900 of monitoring new business acquisition and determining elasticity (or change in demand or sales) caused by one or more changes or updates to insurance policy terms, conditions, and characteristics 902. The method 900 may include determining, via one or more processors, an actual change, future change, or update to one or more characteristics or parameters of new insurance policies or a type of insurance policy 902. The actual change, future change, or update to the insurance policies or a group of insurance policies may be related to a change, future change, or update to price, rate, premium, discounts, conditions, endorsements, deductibles, coverages, limits, and/or other insurance contract parameters or variables. The one or more characteristics or parameters of the insurance policy may be related to a change, future change, or update to price, rate, premium, discounts, conditions, endorsements, deductibles, coverages, limits, and/or other insurance contract parameters or variables.

The method 900 may include estimating, via the one or more processors, an estimated measure of elasticity for, or a rate of change of, new policy issuance 904. For instance, given a known increase in an insurance discount or a known decrease in premium, an increase in new business acquisition may be estimated or predicted, such as by using historical or past sales and pricing data. The estimated measure of elasticity for, or a rate of change of, new policy issuance may be estimated based at least in part upon the known change to the new insurance policies.

The method 900 may include receiving, via the one or more processors and/or associated transceivers, new insurance policy data, existing insurance policy, and/or other data 906. The new insurance policy data may be associated with newly issued insurance policies that have been updated or adjusted to include the known change or update. For instance, after a new insurance discount goes into effect for a line of business, newly written insurance policies for a type of insurance (e.g., auto, life, or homeowners) may all reflect the new discount, with new customers receiving the new discount.

The new insurance policy data may include mobile device, social media, and/or online purchasing data, and the new and existing insurance policy data may be received, gathered, or collected with customer permission or affirmative consent, such as with opt-in into a rewards, sales, or discount online program. Additionally or alternatively, the insurance policy data may include website, browsing history, online quote request, and/or websites visited or frequented data, and the new and existing insurance policy data may be received, gathered, or collected with customer permission or affirmative consent, such as with opt-in into a rewards, sales, or discount online program.

The method 900 may include inputting, via the one or more processors, the new insurance policy data, existing insurance policy data, and/or other data into a machine learning module trained to identify an actual measure of elasticity for, or a rate of change of, new policy issuance related to, based upon, or caused by the known policy change or update by customer segment 908. For instance, the machine learning module may be trained to first identify customer segments within the new and/or existing insurance policy data, such as customer segments associated with line of business or type of insurance, tenure, age, state or other location, credit score, employment status, marital status, etc. Additionally or alternatively, the one or more customer segments may be determined from processor or machine learning module analysis of mobile device and/or social media data, with the new insurance policy data, existing insurance policy data, and/or other data being received, gathered, or collected with customer permission or affirmative consent, such as with opt-in into a rewards, sales, or discount online program.

After which, the machine learning module may be further trained to then identify an actual measure of elasticity for, or rate of change of, new policy issuance within each customer segment.

The method 900 may include comparing, via the one or more processors, the actual measure of elasticity for (or actual rate of change of) new policy issuance determined by the machine learning module with the estimated measure of elasticity for (or estimated rate of change of) new policy issuance for one or more customer segments 910. Additionally or alternatively, the method 900 may include determining, via the one or more processors, if the actual measure of elasticity for (or actual rate of change of) new policy issuance varies or differs from the estimated measure of elasticity for (or actual rate of change of) new policy issuance by more than a predetermined threshold, such as increase or decrease by 5, 10, or 20% when compared to policy issuance prior to the change or update to the new insurance policies.

If the actual elasticity varies from the estimated elasticity by more than the predetermined threshold, then the one or more processors may take corrective action 912. For instance, the one or more processors may initiate or increase discounts if new policy issuance drops further than estimated or desired. Additionally or alternatively, the one or more processors may remove the change or update to new policies being written. Additionally or alternatively, the corrective action may include adjusting the change or update in insurance policies that are being or planned to be subsequently newly issued (i) to reach a target number of new insurance policies being issued, (ii) to reach a target number of new insurance policies being issued based upon the actual measure of elasticity; or (iii) to match a desired rate of change in new policy issuance.

The method 900 may include continuing, via the one or more processors, monitoring elasticity for, and/or rate of change of new policy issuance 914, such as by continuing to receive additional new policy data, and continuing to feed the additional new policy data into the machine learning module trained to identify elasticity in new policy issuance for one or more customer segments caused by the known changes or updates to policy parameters, conditions, pricing, etc.

### Supervised Machine Learning—Elasticity of Renewal & Cancellation

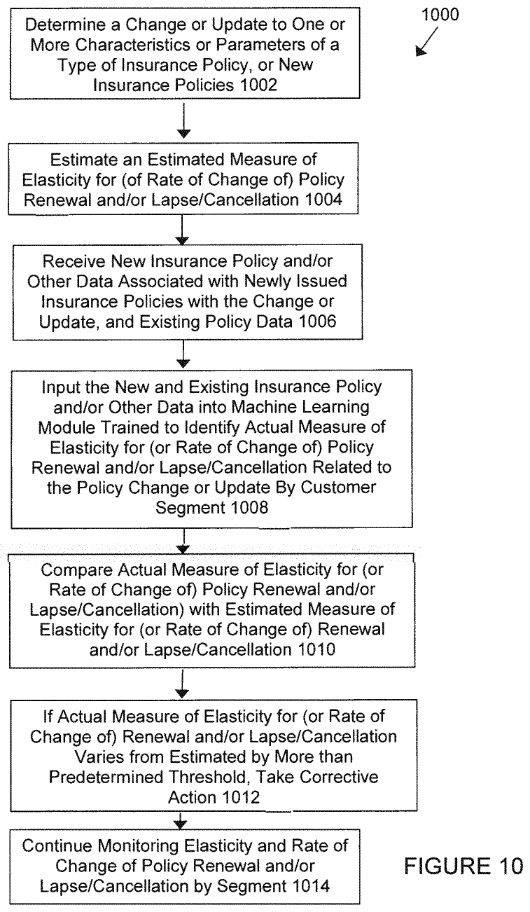

FIG. 10 depicts a computer-implemented method 1000 of monitoring renewal of existing business and/or lapse/cancellation of existing business, and determining elasticity (or change in demand or sales) caused by one or more changes or updates to insurance policy terms, conditions, and characteristics 1002. The method 1000 may include determining, via one or more processors, an actual change, future change, or update to one or more characteristics or parameters of new insurance policies or a type of insurance policy 1002. The actual change, future change, or update to the insurance policies or a group of insurance policies may be related to a change, future change, or update to price, rate, premium, discounts, conditions, endorsements, deductibles, coverages, limits, and/or other insurance contract parameters or variables. The one or more characteristics or parameters of the insurance policy may be related to a change, future change, or update to price, rate, premium, discounts, conditions, endorsements, deductibles, coverages, limits, and/or other insurance contract parameters or variables.

The method 1000 may include estimating, via the one or more processors, an estimated measure of elasticity for, or a rate of change of, policy renewal and/or policy lapse/cancellation 1004. For instance, given a known increase in an insurance discount or a known decrease in premium, an increase in policy renewal or drop in policy lapse/cancellation may be estimated or predicted, such as by using historical or past sales and pricing data.

The method 1000 may include receiving, via the one or more processors and/or associated transceivers, new insurance policy data, existing insurance policy data, and/or other data. The new insurance policy data that is associated with renewed and/or cancelled insurance policies that have been updated or adjusted to include the known change or update 1006. For instance, after a new insurance discount goes into effect for a line of business, newly written insurance policies for a type of insurance (e.g., auto, life, or homeowners) may all reflect the new discount, with new customers receiving the new discount.

The new insurance policy data may include mobile device, social media, and/or online purchasing data, the new insurance policy data may be received, gathered, or collected with customer permission or affirmative consent, such as with opt-in into a rewards, sales, or discount online program. Additionally or alternatively, the insurance policy data may include website, browsing history, online quote request, and/or websites visited or frequented data, the new insurance policy data may be received, gathered, or collected with customer permission or affirmative consent, such as with opt-in into a rewards, sales, or discount online program.

The method 1000 may include inputting, via the one or more processors, the new insurance policy data, existing insurance policy data, and/or other data into a machine learning module trained to identify an actual measure of elasticity for, or a rate of change of, policy renewal and/or policy lapse/cancellation related to, based upon, or caused by the known policy change or update by customer segment 1008. For instance, the machine learning module may be trained to first identify customer segments within the new insurance policy data, such as customer segments associated with line of business or type of insurance, tenure, age, state or other location, credit score, employment status, marital status, etc.

Additionally or alternatively, the one or more customer segments may be determined from processor or machine learning module analysis of mobile device and/or social media data, and the new insurance policy data, existing insurance policy data, and/or other data may be received, gathered, or collected with customer permission or affirmative consent, such as with opt-in into a rewards, sales, or discount online program. After which, the machine learning module may be further trained to then identify an actual measure of elasticity for, or rate of change of, policy renewal and/or lapse or cancellation within each customer segment.

The method 1000 may include comparing, via the one or more processors, the actual measure of elasticity for, or actual rate of change of, policy renewal and/or lapse/cancellation determined by the machine learning module with the estimated measure of elasticity for, or estimated rate of change of, policy renewal and/or lapse/cancellation for one or more customer segments 1010. Additionally or alternatively, the method 1000 may include determining, via the one or more processors, if the actual measure of elasticity for, or actual rate of change of, policy renewal and/or lapse/cancellation varies or differs from the estimated measure of elasticity for, or estimate rate of change of, policy renewal and/or lapse/cancellation by more than a predetermined threshold, such as increasing or decreasing by 5, 10, or 20% as compared to policy renewal and/or lapse/cancellation rates prior to the change or update to the new insurance policies being implemented.

If the actual elasticity varies from the estimated elasticity by more than the predetermined threshold, then the one or more processors may take corrective action 1012. For instance, the one or more processors may initiate or increase discounts if policy renewal drops further than estimated or lapse or cancellation numbers increase. Additionally or alternatively, the one or more processors may remove the change or update to new policies being written. Additionally or alternatively, the corrective action may include adjusting the change or update in insurance policies that are being or planned to be subsequently newly (i) to reach a target number of policy renewals, (ii) to reach a target number of lapsed and/or cancelled policies, or (iii) to match a desired rate of change in policy renewal, and/or policy lapse and/or cancellation.

The method 1000 may include continuing, via the one or more processors, monitoring elasticity for, and/or rate of change of, policy renewal and/or lapse/cancellation 1014, such as by continuing to receive additional new policy data, and continuing to feed the additional new policy data into the machine learning module trained to identify elasticity in policy renewal for one or more customer segments caused by the identified or determined changes or updates to policy parameters, conditions, pricing, etc.

### Unsupervised Machine Learning—Elasticity of New Business Acquisition

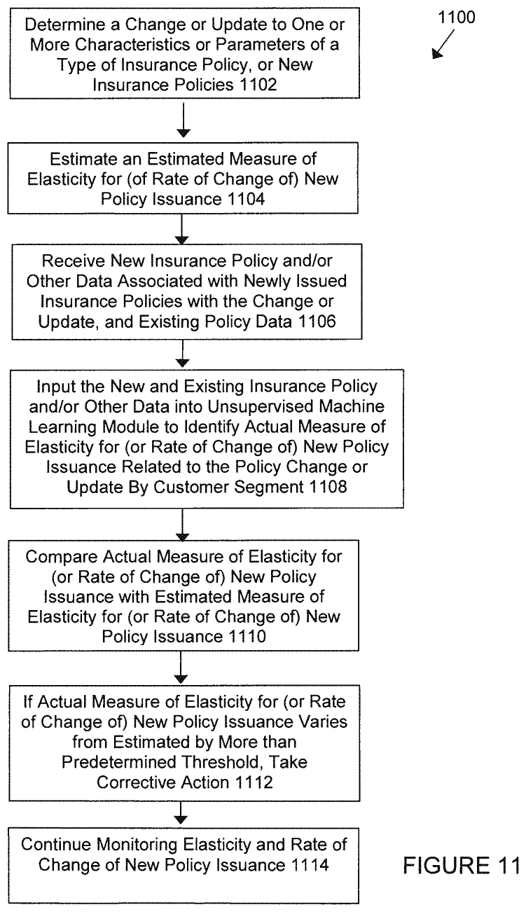

FIG. 11 depicts a computer-implemented method 1100 of monitoring new business acquisition and determining elasticity (or change in demand or sales) caused by one or more changes or updates to insurance policy terms, conditions, and characteristics 1102. The method 1100 may include determining, via one or more processors, an actual change, future change, or update to one or more characteristics or parameters of an insurance policy or a type of insurance policy 1102. The actual change, future change, or update to the insurance policy or a group of insurance policies may be related to a change, future change, or update to price, rate, premium, discounts, conditions, endorsements, deductibles, coverages, limits, and/or other insurance contract-related parameters or variables. The one or more characteristics or parameters of the insurance policy may be related to change, future change, or update to price, rate, premium, discounts, conditions, endorsements, deductibles, coverages, limits, and/or other parameters.

The method 1100 may include estimating, via the one or more processors, an estimated measure of elasticity for, or a rate of change of, new policy issuance 1104. For instance, given an identified or known increase in an insurance discount or an identified or known decrease in premium, an increase in new business acquisition may be estimated or predicted, such as by using historical sales and pricing data.

The method 1100 may include receiving, via the one or more processors and/or associated transceivers, new insurance policy data, existing insurance policy data, and/or other data. The new insurance policy data may be associated with newly issued insurance policies that have been updated or adjusted to include the identified, determined, or known change or update 1106. For instance, after a new insurance discount goes into effect for a line of business, newly written insurance policies for a type of insurance (e.g., auto, life, or homeowners) may all reflect the new discount, with new customers receiving the new discount.

The new insurance policy data may include mobile device, social media, and/or online purchasing data, and the new insurance policy data may be received, gathered, or collected with customer permission or affirmative consent, such as with opt-in into a rewards, sales, or discount online program. Additionally or alternatively, the insurance policy data may include website, browsing history, online quote request, and/or websites visited or frequented data, and the new insurance policy data may be received, gathered, or collected with customer permission or affirmative consent, such as with opt-in into a rewards, sales, or discount online program.

The method 1100 may include inputting, via the one or more processors, the new insurance policy data, existing insurance policy data, and/or other data into an unsupervised machine learning module to identify an actual measure of elasticity, or a rate of change of new policy issuance related to, based upon, or caused by the known policy change or update by customer segment 1108. For instance, the machine learning module may first identify customer segments within the new insurance policy data, such as customer segments associated with line of business or type of insurance, tenure, age, state or other location, credit score, employment status, marital status, etc. Additionally or alternatively, the one or more customer segments may be determined from unsupervised machine learning module analysis of mobile device and/or social media data. The new insurance policy data and/or other data may be received, gathered, or collected with customer permission or affirmative consent, such as with opt-in into a rewards, sales, or discount online program.

After which, the unsupervised machine learning module may further identify an actual measure of elasticity for, or rate of change of, new policy issuance within each customer segment.

The method 1100 may include comparing, via the one or more processors, the actual measure of elasticity for (or actual rate of change of) new policy issuance determined by the machine learning module with the estimated measure of elasticity for (or estimated rate of change of) new policy issuance for one or more customer segments 1110. Additionally or alternatively, the method 1100 may include determining, via the one or more processors, if the actual measure of elasticity for (or actual rate of change of) new policy issuance varies or differs from the estimated measure of elasticity (or actual rate of change of) new policy issuance by more than a predetermined threshold, such as an increase or decrease of 5, 10, or 20% as compared to policy issuance prior to the change being implemented.

If the actual elasticity varies from the estimated elasticity by more than the predetermined threshold, then the one or more processors may take corrective action 1112. For instance, the one or more processors may initiate or increase discounts if policy issuance drops further than estimated. Additionally or alternatively, the one or more processors may remove the change or update to new policies being written. Additionally or alternatively, the corrective action may include adjusting the change or update in insurance policies that are being or planned to be subsequently newly issued (i) to reach a target number of new insurance policies being issued, (ii) to reach a target number of new insurance policies being issued based upon the actual measure of elasticity; or (iii) to match a desired rate of change in new policy issuance.

The method 1100 may include continuing, via the one or more processors, monitoring elasticity for, and/or rate of change of, new policy issuance 1114, such as by continuing to receive additional new policy data, and continuing to feed the additional new policy data into the machine learning module to identify elasticity in new policy issuance for one or more customer segments caused by the known or determined changes or updates to policy parameters, conditions, pricing, etc.

### Unsupervised Machine Learning—Elasticity of Renewal & Cancellation

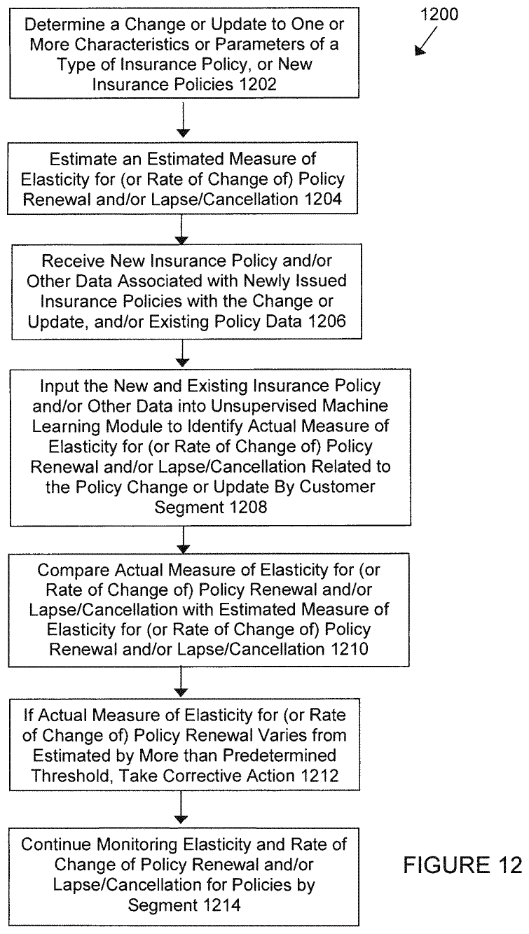

FIG. 12 depicts a computer-implemented method 1200 of monitoring renewal of existing business and/or lapse/cancellation of existing business, and determining elasticity (or change in demand or sales) caused by one or more changes or updates to insurance policy terms, conditions, and characteristics 1202. The method 1200 may include determining, via one or more processors, an actual change, future change, or update to one or more characteristics or parameters of new insurance policies or a type of insurance policy 1202. The actual change, future change, or update to the new insurance policies or a group of insurance policies may be related to a change, future change, or update to price, rate, premium, discounts, conditions, endorsements, deductibles, coverages, limits, and/or other insurance-related parameters or variables. The one or more characteristics or parameters of the insurance policies may be related to a change, future change, or update to price, rate, premium, discounts, conditions, endorsements, deductibles, coverages, limits, and/or other insurance-related parameters or variables.

The method 1200 may include estimating, via the one or more processors, an estimated measure of elasticity for, or a rate of change of, policy renewal and/or policy lapse/cancellation 1204. For instance, given a known increase in an insurance discount or a known decrease in premium, an increase in policy renewal or drop in policy lapse/cancellation may be estimated or predicted, such as by using historical sales and pricing data.

The method 1200 may include receiving, via the one or more processors and/or associated transceivers, new insurance policy data, existing insurance policy data, and/or other data. The new insurance policy data may be associated with renewed, lapsed, and/or cancelled insurance policies that have been updated or adjusted to include the known or identified change or update 1206. For instance, after a new insurance discount goes into effect for a line of business, newly written insurance policies for a type of insurance (e.g., auto, life, or homeowners) may all reflect the new discount, with new customers receiving the new discount.

The new insurance policy data may include mobile device, social media, and/or online purchasing data, and the new insurance policy data and/or other data may be received, gathered, or collected with customer permission or affirmative consent, such as with opt-in into a rewards, sales, or discount online program. Additionally or alternatively, the insurance policy data may include website, browsing history, online quote request, and/or websites visited or frequented data, and the new insurance policy data and/or other data may be received, gathered, or collected with customer permission or affirmative consent, such as with opt-in into a rewards, sales, or discount online program.

The method 1200 may include inputting, via the one or more processors, the new insurance policy data, existing insurance policy data, and/or other data, into an unsupervised machine learning module to identify an actual measure of elasticity for, or a rate of change of, policy renewal and/or policy lapse/cancellation related to, based upon, or caused by the known policy change or update by customer segment 1208. For instance, the unsupervised machine learning module may first identify customer segments within the new insurance policy data, such as customer segments associated with line of business or type of insurance, tenure, age, state or other location, credit score, employment status, marital status, etc. Additionally or alternatively, the one or more customer segments may be determined from unsupervised machine learning module analysis of mobile device and/or social media data, and the new or existing insurance policy data and/or other data may be received, gathered, or collected with customer permission or affirmative consent, such as with opt-in into a rewards, sales, or discount online program. After which, the unsupervised machine learning module may identify an actual measure of elasticity for, or rate of change of, policy renewal and/or lapse/cancellation within each customer segment.

The method 1200 may include comparing, via the one or more processors, the actual measure of elasticity for (or actual rate of change of) policy renewal and/or lapse/cancellation determined by the unsupervised machine learning module with the estimated measure of elasticity for (or estimated rate of change of) policy renewal and/or lapse/cancellation for one or more customer segments 1210. Additionally or alternatively, the method 1200 may include determining, via the one or more processors, if the actual measure of elasticity for (or actual rate of change of) policy renewal and/or lapse/cancellation varies or differs from the estimated measure of elasticity of (or actual rate of change of) policy renewal and/or lapse/cancellation by more than a predetermined threshold, such as an increase or decrease of 5, 10, or 20% as compared to policy renewal and/or lapse/cancellation rates prior to the change in new policies taking effect.

If the actual elasticity varies from the estimated elasticity by more than the predetermined threshold, then the one or more processors may take corrective action 1212. For instance, the one or more processors may initiate or increase discounts if policy renewal drops further than estimated or lapse or cancellation numbers increase. Additionally or alternatively, the one or more processors may remove the change or update to new policies being written. Additionally or alternatively, the corrective action may include adjusting the change or update in insurance policies that are being or planned to be subsequently newly issued (i) to reach a target number of policy renewals, (ii) to reach a target number of lapsed and/or cancelled policies, or (iii) to match a desired rate of change in policy renewal, and/or policy lapse and/or cancellation.

The method 1200 may include continuing, via the one or more processors, monitoring elasticity and/or rate of change in issuance of new policies 1214, such as by continuing to receive additional new policy data, and continuing to feed the additional new policy data into the unsupervised machine learning module to identify elasticity in policy renewal for one or more customer segments caused by the known changes or updates to policy parameters, conditions, pricing, etc.

### Exemplary Method for Operating an Adaptive Insurance Policy System

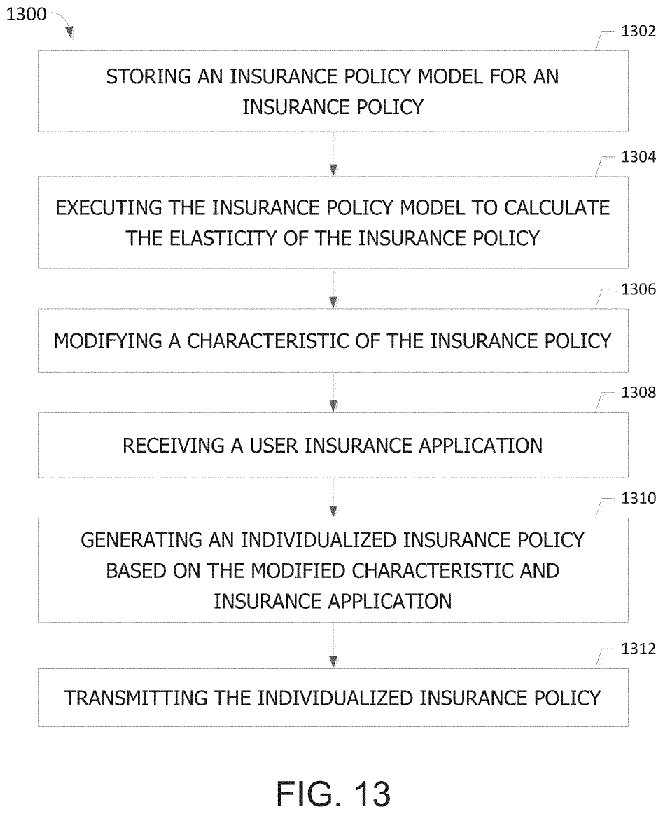

FIG. 13 depicts a computer-implemented method 1300 for operating an adaptive insurance policy system. In some embodiments, the adaptive insurance policy system discussed herein may use one or more processors in communication with at least one memory device. The method 1300 may include storing 1302 an insurance policy model for an insurance policy. The method 1300 may further include executing 1304 the insurance policy model to calculate the elasticity of the insurance policy. The method 1300 may further include modifying 1306 a characteristic of the insurance policy. The method 1300 may further include receiving 1308 a user insurance application. The method 1300 may further include generating 1310 an individualized insurance policy based upon the modified characteristic and insurance application. The method 1300 may further include transmitting 1312 the individualized insurance policy.

In some embodiments, executing 1304 the insurance policy model includes receiving recent insurance policy data for a period of time and inputting the recent insurance policy data into the insurance policy model. In some embodiments, method 1300 includes receiving input transmitted from a user computing device and applying the input entered into the insurance policy model. In some embodiments, the insurance policy model is a trained neural network. The insurance policy model is then executed to produce weights indicating risk.

In some embodiments, method 1300 includes generating a predicted elasticity for the insurance policy for a future period. The predicted elasticity may be based upon the detected change to the at least one characteristic of the plurality of characteristics of the insurance policy. The predicted elasticity may then be compared to the calculated elasticity for the insurance policy to determine whether the calculated elasticity deviates from the predicted elasticity by a predetermined threshold. In some embodiments, the predicted elasticity is based upon the historical insurance policy data. The historical insurance policy data may include at least a past change to at least one characteristic of the plurality of characteristics of the insurance policy. In some embodiments the calculated elasticity for the insurance policy is a price elasticity, the predicted elasticity for the insurance policy is a predicted price elasticity and the plurality of characteristics of the insurance policy is one of a premium and a discount.

In some embodiments, the calculated elasticity is associated with insurance product characteristics and coverage. Modifying 1306 the at least one characteristic of the plurality of characteristics of the insurance policy is a modification of one of a coverage, limit, condition, deductible, and endorsement. In some embodiments, modifying 1306 the at least one characteristic of the plurality of characteristics of the insurance policy is one of a premium, price, rate, discount, coverage, limit condition, deductible, and endorsement. In some embodiments, modifying 1306 a characteristic of the insurance policy may be based upon a target rate of change of new issuances of the insurance policy. In other embodiments, modifying 1306 a characteristic of the insurance policy may be based upon a target number of issuances of the insurance policy. In some embodiments, the target number of issuances is based upon the calculated elasticity of the insurance policy.

In some embodiments, storing 1302 the insurance policy model includes storing a plurality of characteristics for the insurance policy and historical insurance policy data. The historical insurance policy data may include a plurality of individual insurance policies. The individual insurance policies may be one of auto, life, homeowners, personal articles, and health. The historical insurance policy data may be one of renewal policy data, lapsed, policy data, canceled policy data, sales data, new policy offer data, recently issued policy data, existing policy data, mobile device data, website data, browsing data, online purchasing data, and social media data. In some embodiments, the plurality of characteristics for the insurance policy may be one of age, geographical location, state, credit score, marital status, driving status, employment status, line of business, tenure, return customer, frequent shopper, mobile device usage, and type of mobile device.

In some embodiments, storing 1302 the insurance policy model including historical insurance policy data may be historical insurance policy data generated with affirmative consent. For example, the affirmative consent may be an opt-in for one of sales, rewards, and discount online program.

In some embodiments, storing 1302 the insurance policy model may be storing a supervised machine learning model. In other embodiments, storing 1302 maybe storing an unsupervised machine learning model.

In some embodiments, executing 1304 the insurance policy model to calculate the elasticity of the insurance policy may be based upon a known change to the at least one characteristic of the plurality of characteristics of the insurance policy. In some embodiments, the calculation of the elasticity of the insurance policy is a calculation of elasticity for a new insurance policy. In other embodiments, the calculation is for a renewal insurance policy. In yet other embodiments, the calculation is for a cancellation of the insurance policy.

### Exemplary Adaptive Insurance Policy System

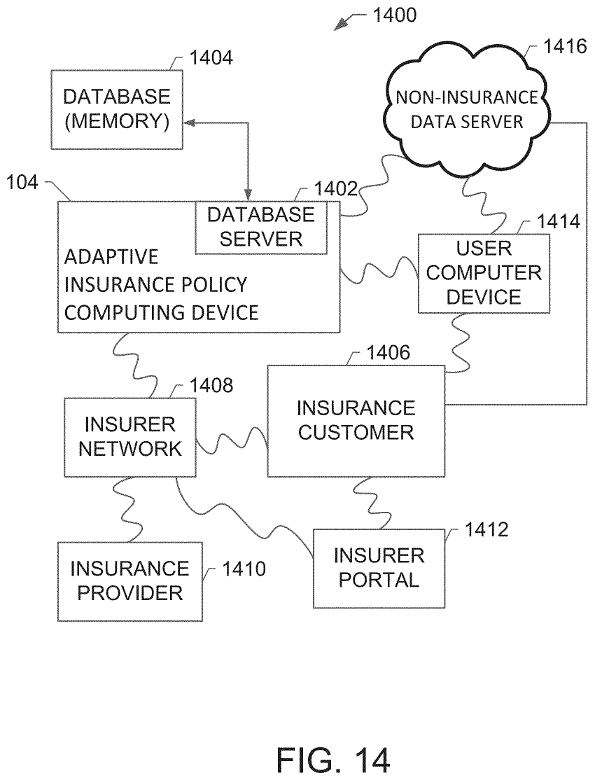

FIG. 14 illustrates an exemplary block diagram of an adaptive insurance policy system 1400. In the exemplary embodiment, the adaptive insurance policy system 1400 may include an adaptive insurance policy computing device 104. In some embodiments, adaptive insurance policy computing device 104 includes a database server 1402. Database server 1402 may be in communication with a database and/or memory device 1404. In some embodiments, database 1404 comprises historical insurance data. Database 1404 may further comprise non-insurance data.

In the exemplary embodiment, an insurance customer 1406 may communicate with adaptive insurance policy computing device 104 via insurer network 1408. In addition, insurance provider 1410 may be in communication with adaptive insurance policy computing device 104 via insurer network 1408. Insurance customer 1406 may be in communication with an insurer portal 1412. Insurer portal 1412 may communicate with insurance provider 1410 via insurer network 1408. Insurer portal 1412 may also be in communication with adaptive insurance policy computing device 104 via insurer network 1408.

In the exemplary embodiment, insurance customer 1406 may also communicate with adaptive insurance policy computing device 104 using a user computer device 1414. User computer device 1414 may be configured to transmit data to non-insurance data server 1416. Non-insurance data sever 1416 may be, for example, third-party data management entities and may store data such as demographic, geographical, physical, and/or other data. In some embodiments, insurance customer 1406 may be in direct communication with non-insurance data server 1416 or may communicate with non-insurance data server 1416 using other means such as via post mail.

### Exemplary User Computer Device

FIG. 15 illustrates an exemplary configuration 1500 of an exemplary user computing device 1502. In some embodiments, user computing device 1502 may be client device 202 (shown in FIG. 2) or user computing device 1414 (shown in FIG. 14).

User computer device 1502 may be operated by a user 1504 (e.g., an insurance customer). User computer device 1502 may receive input from user 1504 via an input module 1506. User computer device 1502 includes a processor 1508 for executing instructions. In some embodiments, executable instructions may be stored in a memory area 1510. Processor 1508 may include one or more processing units (e.g., in a multi-core configuration). Memory area 1510 may be any device allowing information such as executable instructions and/or transaction data to be stored and retrieved. Memory area 1510 may include one or more computer-readable media.

User computer device 1502 also may include at least one media output component 1512 for presenting information to user 1504. Media output component 1512 may be any component capable of conveying information to user 1504. In some embodiments, media output component 1512 may include an output adapter (not shown), such as a video adapter and/or an audio adapter. An output adapter may be operatively coupled to processor 1508 and operatively coupleable to an output device, such as a display device (e.g., a cathode ray tube (CRT), liquid crystal display (LCD), light emitting diode (LED) display, or “electronic ink” display) or an audio output device (e.g., a speaker or headphones).

In some embodiments, media output component 1512 may be configured to present a graphical user interface (e.g., a web browser and/or a client application) to user 1504. A graphical user interface may include, for example, an insurance application with options for selecting varying insurance policies, and/or a wallet application for managing payment information such as cash and/or cryptocurrency payment methods.

In some embodiments, user computer device 1502 may include an input device for receiving input from user 1504. User 1504 may use input devices to, without limitation, interact with insurance policy computing device 104 (shown in FIG. 1), non-insurance data server 1416 (shown in FIG. 14), or insurance provider 1410 (shown in FIG. 14). Input devices may include, for example, a keyboard, a pointing device, a mouse, a stylus, and/or a touch sensitive panel (e.g., a touch pad or a touch screen). A single component, such as a touch screen, may function as both an output device of media output component 1512 and an input device. User 1504 further may include at least one sensor, including, for example, a gyroscope, an accelerometer, a position detector, a biometric input device, a telematics data collection device, and/or an audio input device. In some embodiments, at least some data collected by user 1504 may be transmitted to insurance provider 1410 to, for example, generate models. In the exemplary embodiment, data collected by user computer device 1502 may be included in a claim submission. In some embodiments, data collected by user computer device 1502 is distributed to a non-insurance data server to be store in a database.

User computer device 1502 may also include a communication interface 1514, communicatively coupled to insurance provider 1410 (shown in FIG. 14) or insurer network 1408 (shown in FIG. 14). Communication interface 1514 may include, for example, a wired or wireless network adapter and/or a wireless data transceiver for use with a mobile telecommunications network.

Stored in memory area 1510 may be, for example, computer-readable instructions for providing a user interface to user 1504 via media output component 1512 and, optionally, receiving and processing input from an input device using input module 1506. The user interface may include, among other possibilities, a web browser and/or a client application. Web browsers enable users, such as user 1504, to display and interact with media and other information typically embedded on a web page or a website hosted by insurance provider 1410 and/or user computer device 1502. A client application may allow user 1504 to interact with, for example, adaptive insurance policy computing device 104 (shown in FIG. 1), non-insurance data server 1416 (shown in FIG. 14), and insurer portal 1412 (shown in FIG. 4). For example, instructions may be stored by a cloud service and the output of the execution of the instructions sent to the media output component 1512.

### Exemplary Server Device

FIG. 16 depicts an exemplary configuration 1600 of an exemplary server computing device 1601, in accordance with one embodiment of the present disclosure. Server computing device 1601 may include, but is not limited to, adaptive insurance policy computing device 104 (shown in FIG. 1), the server device 204 (shown in FIG. 2), and the database server 1416 (shown in FIG. 14). Server computer device 1601 may include a processor 1605 for executing instructions. Instructions may be stored in a memory area 1610. Processor 1605 may include one or more processing units (e.g., in a multi-core configuration).

Processor 1605 may be operatively coupled to a communication interface 1615 such that server computer device 1601 may be capable of communicating with a remote device such as another server computer device 1601 or user computing device 1414 (shown in FIG. 14). For example, communication interface 1615 may receive requests from or transmit requests to user computer device 1502 (shown in FIG. 14) via the Internet.

Processor 1605 may also be operatively coupled to a storage device 1620. Storage device 1620 may be any computer-operated hardware suitable for storing and/or retrieving data, such as, but not limited to, historical insurance data, new insurance data, and non-insurance data. In some embodiments, storage device 1620 may be integrated in server computer device 1601. For example, server computer device 1601 may include one or more hard disk drives as storage device 1620. In other embodiments, storage device 1620 may be external to server computer device 1601 and may be accessed by a plurality of server computer devices 1601. For example, storage device 1620 may include a storage area network (SAN), a network attached storage (NAS) system, and/or multiple storage units such as hard disks and/or solid state disks in a redundant array of inexpensive disks (RAID) configuration.

In some embodiments, processor 1605 may be operatively coupled to storage device 1620 via a storage interface 1625. Storage interface 1625 may be any component capable of providing processor 1605 with access to storage device 1620. Storage interface 1625 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1605 with access to storage device 1620.

Processor 1605 executes computer-executable instructions for implementing aspects of the disclosure. In some embodiments, processor 1605 may be transformed into a special purpose microprocessor by executing computer-executable instructions or by otherwise being programmed. For example, processor 1605 may be programmed with the instructions with such as those illustrated in the figures presented herein.

### Exemplary Embodiments & Functionality

In one aspect, a computerized machine learning system for determining an elasticity of an insurance policy may be provided. The computerized machine learning system may include one or more processors in communication with at least one memory device. The one or more processors are programmed to store an insurance policy model including a plurality of characteristics for the insurance policy and historical insurance policy data. The historical insurance policy data may include a plurality of individual insurance policies. The one or more processors are further programmed to execute the insurance policy model to calculate an estimate of elasticity of the insurance policy (or a measure of elasticity of the insurance policy). The calculation is based upon analyzing the historical insurance policy data to detect a change to at least one characteristic of the plurality of characteristics of the insurance policy. The one or more processors are further programmed to modify at least one characteristic of the plurality of characteristics of the insurance policy based upon the calculated estimate of elasticity. The one or more processors are further programmed to receive, from a user computing device, a user insurance application. The one or more processors are further programmed to generate an individualized insurance policy based upon the application and the at least one modified characteristic. The one or more processors are further programmed to transmit, to the user computing device, the individualized insurance policy.

One enhancement may be where executing the insurance policy model includes receiving recent insurance policy data for a period of time and inputting the recent insurance policy data into the insurance policy model.

Another enhancement may be where the one or more processors are further programmed to receive input transmitted from the user computing device, and apply the input entered into the insurance policy model. The insurance policy model may be a trained neural network model, to produce weights indicating risk.

A further enhancement may be where the one or more processors are further programmed to generate, via the one or more processors, a predicted elasticity for the insurance policy for a future period, based upon the detected change to the at least one characteristic of the plurality of characteristics of the insurance policy. The one or more processors may be further programmed to compare, via the one or more processors, the predicted elasticity and the calculated estimate of elasticity for the insurance policy to determine whether the calculated estimate of elasticity for the insurance policy deviates from the predicted elasticity for the insurance policy by a predetermined threshold.

A further enhancement may be where the predicted elasticity is based upon the historical insurance policy data, the historical insurance policy data including at least a past change to at least one characteristic of the plurality of characteristics of the insurance policy.

A further enhancement may be where the calculated estimate of elasticity for the insurance policy may be a price elasticity. The predicted elasticity for the insurance policy may be a predicted price elasticity. The plurality of characteristics of the insurance policy may be one of a premium and a discount.

A further enhancement may be where the calculated estimate of elasticity is associated with insurance product characteristics and coverage. The modification to the at least one characteristic of the plurality of characteristics of the insurance policy may be one of a coverage, limit, condition, deductible, and endorsement.

A further enhancement may be where the individualized insurance policy is one of auto, life, and homeowners, personal articles, and health.

A further enhancement may be where the modification to the at least one characteristic of the plurality of characteristics of the insurance policy is based upon a target rate of change of new issuances of the insurance policy.

A further enhancement may be where the modification to the at least one characteristic of the plurality of characteristics of the insurance policy is based upon a target number of issuances of the insurance policy.

A further enhancement may be where the target number of issuances of the insurance policy is based upon the calculated estimate of elasticity of the insurance policy.

A further enhancement may be where the historical insurance policy data includes one of a renewal policy data, lapsed policy data, canceled policy data, sales data, new policy offer data, recently issued policy data, existing policy data, mobile device data, website data, browsing data, online purchasing data, and social media data.

A further enhancement may be where the plurality of characteristics for the insurance policy is one of age, geographical location, state, credit score, marital status, driving status, employment status, line of business, tenure, return customer, frequent shopper, mobile device usage, and type of mobile device.

A further enhancement may be where the historical insurance policy data is generated with affirmative consent. The affirmative consent may be an opt-in for one of a rewards, sales, and discount online program.

A further enhancement may be where the insurance policy model is one of a supervised machine learning model and an unsupervised machine learning model. In one embodiment, the insurance policy model may be a combination of both a supervised machine learning model and an unsupervised machine learning model.

A further enhancement may be where the calculation of the estimate of elasticity of the insurance policy is based upon a known change to the at least one characteristic of the plurality of characteristics of the insurance policy.

A further enhancement may be where the calculation of the estimate of elasticity of the insurance policy is a calculation of an estimate of elasticity for one of a new insurance policy, renewal insurance policy, or cancellation of an insurance policy.

In some embodiments, an estimate of elasticity may be calculated, or otherwise determined, as noted above. In other embodiments, another measure or measurement of elasticity may be calculated, or otherwise determined. In yet other embodiments, actual elasticity may be calculated, or otherwise determined.

### Technical Advantages

The aspects described herein may be implemented as part of one or more computer components such as a client device and/or one or more back-end components, such as a customer assessment engine, for example. Furthermore, the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

For instance, aspects include analyzing various sources of data to identify elasticity, or measure of elasticity (such as an estimate of elasticity), corresponding to various changes to new insurance policies that may otherwise go unnoticed for some time. In doing so, the aspects overcome issues associated with the inconvenience of manual and/or unnecessary monitoring of data by replacing manual procedures with a cognitive-based computing system. Without the improvements suggested herein, additional processing and memory usage would be required to perform such monitoring. Additional technical advantages include, but are not limited to: i) improved speed and responsiveness in responding to the market; ii) real-time analysis of demand elasticity; and iii) updating policies and other products in real-time to address different issues that may affect the demand. Additional technical advantages are described in other sections of the specification.

Furthermore, the embodiments described herein improve upon existing technologies, and improve the functionality of computers, by more accurately predict or identify emerging trends, and identify and verify the root causes thereof. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to efficiency metrics, for example.

### ADDITIONAL CONSIDERATIONS

With the foregoing, any users (e.g., insurance customers) whose data is being collected and/or utilized may first opt-in to a rewards, insurance discount, or other type of program. After the user provides their affirmative consent or permission, data may be collected from the user's devices (e.g., mobile device, smart or autonomous vehicle controller, smart home controller, or other smart devices). In return, the user may be entitled insurance cost savings, including insurance discounts for auto, homeowners, mobile, renters, personal articles, life, health, and/or other types of insurance.

In the above description, neural networks may also refer to other methods of artificial intelligence and machine learning. In other embodiments, deployment and use of neural network models at a user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for a system and a process of performing the methods and systems disclosed herein, using the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computerized machine learning system for determining an estimate of elasticity of an insurance policy, the system comprising one or more processors in communication with at least one memory device, the one or more processors programmed to:
store an insurance policy model including a plurality of characteristics for the insurance policy and historical insurance policy data, wherein the historical insurance policy data includes a plurality of individual insurance policies;
execute the insurance policy model to calculate an estimate of elasticity of the insurance policy, wherein the calculation is based upon analyzing the historical insurance policy data to detect a change to at least one characteristic of the plurality of characteristics of the insurance policy;
modify at least one characteristic of the plurality of characteristics of the insurance policy based upon the calculated elasticity;
receive, from a user computing device, a user insurance application;
generate an individualized insurance policy based upon the user insurance application and the at least one modified characteristic; and
transmit, to the user computing device, the individualized insurance policy.

2. The computerized machine learning system of claim 1, wherein executing the insurance policy model includes receiving recent insurance policy data for a period of time and inputting the recent insurance policy data into the insurance policy model.

3. The computerized machine learning system of claim 1, wherein the one or more processors are further programmed to receive input transmitted from the user computing device, and apply the input entered into the insurance policy model, wherein the insurance policy model is a trained neural network model, to produce weights indicating risk.

4. The computerized machine learning system of claim 1, wherein the one or more processors are further programmed to:
generate, via the one or more processors, a predicted elasticity for the insurance policy for a future period, based upon the detected change to the at least one characteristic of the plurality of characteristics of the insurance policy; and
compare, via the one or more processors, the predicted elasticity and the calculated estimate of elasticity for the insurance policy to determine whether the calculated estimate of elasticity for the insurance policy deviates from the predicted elasticity for the insurance policy by a predetermined threshold.

5. The computerized machine learning system of claim 4, wherein the predicted elasticity is based upon the historical insurance policy data, the historical insurance policy data including at least a past change to at least one characteristic of the plurality of characteristics of the insurance policy.

6. The computerized machine learning system of claim 4, wherein the calculated estimate of elasticity for the insurance policy is a price elasticity, wherein the predicted elasticity for the insurance policy is a predicted price elasticity, and wherein the plurality of characteristics of the insurance policy is one of a premium and a discount.

7. The computerized machine learning system of claim 1, wherein the calculated estimate of elasticity is associated with insurance product characteristics and coverage, and wherein the modification to the at least one characteristic of the plurality of characteristics of the insurance policy is one of a coverage, limit, condition, deductible, and endorsement.

8. The computerized machine learning system of claim 1, wherein the modification of the at least one characteristic of the plurality of characteristics of the insurance policy is one of premium, price, rate, discount, coverage, limit, condition, deductible, and endorsement.

9. The computerized machine learning system of claim 1, wherein the individual insurance policy is one of auto, life, homeowners, personal articles, and health.

10. The computerized machine learning system of claim 1, wherein the modification to the at least one characteristic of the plurality of characteristics of the insurance policy is based upon a target rate of change of new issuances of the insurance policy.

11. The computerized machine learning system of claim 1, wherein the modification to the at least one characteristic of the plurality of characteristics of the insurance policy is based upon a target number of issuances of the insurance policy.

12. The computerized machine learning system of claim 11, wherein the target number of issuances of the insurance policy is based upon the calculated estimate of elasticity of the insurance policy.

13. The computerized machine learning system of claim 1, wherein the historical insurance policy data includes one of a renewal policy data, lapsed policy data, canceled policy data, sales data, new policy offer data, recently issued policy data, existing policy data, mobile device data, website data, browsing data, online purchasing data, and social media data.

14. The computerized machine learning system of claim 1, wherein the plurality of characteristics for the insurance policy is one of age, geographical location, state, credit score, marital status, driving status, employment status, line of business, tenure, return customer, frequent shopper, mobile device usage, and type of mobile device.

15. The computerized machine learning system of claim 1, wherein the historical insurance policy data is generated with affirmative consent, wherein the affirmative consent is an opt-in for one of a rewards, sales, and discount online program.

16. The computerized machine learning system of claim 1, wherein the insurance policy model is one of a supervised machine learning model and an unsupervised machine learning model, or both.

17. The computerized machine learning system of claim 1, wherein the calculation of the estimate of elasticity of the insurance policy is based upon a known change to the at least one characteristic of the plurality of characteristics of the insurance policy.

18. The computerized machine learning system of claim 1, wherein the calculation of the estimate of elasticity of the insurance policy is a calculation of an estimate of elasticity for one of a new insurance policy, renewal insurance policy, or cancellation of an insurance policy.

19. A computer-implemented method of determining an estimate of elasticity of an insurance policy, the method implemented using a computer system including one or more processors in communication with at least one memory device, the method comprising:
storing an insurance policy model including a plurality of characteristics for the insurance policy and historical insurance policy data, wherein the historical insurance policy data includes a plurality of individual insurance policies;
executing the insurance policy model to calculate an estimate of elasticity of the insurance policy, wherein the calculation is based upon analyzing the historical insurance policy data to detect a change to at least one characteristic of the plurality of characteristics of the insurance policy;
modifying at least one characteristic of the plurality of characteristics of the insurance policy based upon the calculated elasticity;
receiving, from a user computing device, a user insurance application;
generating an individualized insurance policy based upon the user insurance application and the at least one modified characteristic; and
transmitting, to the user computing device, the individualized insurance policy.

20. A computerized machine learning system for determining a rate of change of new insurance policy issuances, the system comprising one or more processors in communication with at least one memory device, the one or more processors programmed to:
store an insurance policy model including a plurality of characteristics for an insurance policy and historical insurance policy data, wherein the historical insurance policy data includes a plurality of individual insurance policies;
execute the insurance policy model to calculate a rate of change of new insurance policy issuances, wherein the calculation is based upon analyzing the historical insurance policy data to detect a change to at least one characteristic of the plurality of characteristics of the insurance policy;
modify at least one characteristic of the plurality of characteristics for the insurance policy based upon the calculated rate of change;
receive, from a user computing device, a user insurance application;
generate an individualized insurance policy offer based upon the application and the at least one modified characteristic; and
transmit, to the user computing device, the individualized insurance policy.
